(19) United States
(12) Patent Application Publication
(10) Pub. No.: US 2011/0229864 A1
(43) Pub. Date: Sep. 22, 2011

(54) SYSTEM AND METHOD FOR TRAINING

(75) Inventors: John Wayne Short, Kitchener (CA); Rebecca Yvonne Short, Kitchener (CA); Brian Robert Scott, Kitchener (CA); Lara Pawlicz, Kitchener (CA)

(73) Assignee: CORECULTURE INC., Kitchener (CA)

(21) Appl. No.: 12/897,716

(22) Filed: Oct. 4, 2010

Related U.S. Application Data
(60) Provisional application No. 61/248,181, filed on Oct. 2, 2009.

(51) Int. Cl. G09B 19/00

(52) U.S. Cl. 434/219

(57) ABSTRACT

A system and method for training that includes: providing training to a user; testing the user on the training, wherein the testing is performed in short, frequent bursts and continues for a predetermined period of time; and rewarding the user based on results related to the training or testing. In particular, the provision of testing in short, frequent bursts or pulses over a continuous period of time and an iterative manner assists with knowledge retention and reinforcement. The use of a reward system reinforces knowledge and motivates acquisition and retention of knowledge. In a particular case, the rewarding may include providing the user with a chance to win a prize. This approach makes a game out of the reward process to encourage further participation.

### RELATED APPLICATIONS

This application claims priority to U.S. Provisional Patent Application No. 61/248,181 filed on Oct. 2, 2009, which is hereby incorporated by reference in its entirety.

### FIELD

This application relates to a system and method for training, and in particular, to a system and method for adaptive and predictive training using micro-learning techniques.

### BACKGROUND

In most organizations, there are situations where employees, staff or contractors require some training with respect to their jobs or roles. Conventional training typically involves an introduction to the position and the provision of a manual relating to tasks and information needed. This introductory training is often provided at the beginning of the job but there is not always follow-up training due a variety of constraints such as the time demands of setting up a separate training program, the costs involved in follow up training, or a lack of resources to conduct the follow up training. If there is follow-up training, it is often driven by a particular new initiative rather than existing processes and is typically conducted separate from day-to-day work.

In reviewing conventional training, there are two main areas where there are issues: (a) lack of effectiveness of the methods; and (b) low retention rates of information after a communication campaign/blast (for example, a new product launch (marketing), an awareness campaign (health and safety, loss prevention, operations), etc.)

With regard to conventional training, some issues may include:
(a) Training happens on an infrequent basis—hence limiting its efficiency;
(b) Training happens as an event and it can be viewed as a cost factor for department heads, not only the dollar cost of the training but also the time people are off the job;
(c) Training people on things they already know and wasting their time—can be a factor of demotivation;
(d) Training departments will address the needs of the majority of their learners, which means some learners are ahead of the class and get bored by the information, and some learners are behind, and cannot catch up with the course content because they did not have the basic knowledge necessary to grasp the new information. As an example: the younger crowd may be bored by a training module concerning the use of software-based applications to manage sales, inventory, etc. while some of the more mature crowd, who may not have had computer/IT exposure, may need to ramp up from a more basic level;
(e) On-boarding (i.e. hiring and training new staff) can be a very expensive process. As an example: a company has 3,000 employees with a 30% turnover. On-boarding can easily cost $750 per person, for the first two weeks alone. Total cost of on-boarding: $750,000 for information that may only be partially retained plus further costs when the staff leaves and new staff needs to be trained; and
(f) GenY or Millennial groups tend to learn very differently or through different methods or media than GenX or older groups.

Information distribution issues may include:
(a) “campaigns” to communicate with employees can have limited impact because employees are often overly solicited both inside and outside the workplace and the information overload that results from this can desensitize them to new stimulations. Information posters can become wallpaper—sometimes because the campaigns use media that may be less attractive or engaging.
(b) Companies usually are not able to measure the effectiveness of campaigns over the long run. They may measure the immediate recall during or after the campaign, but there is usually little follow-up.
(c) Each department has few opportunities to catch employees' attention: because current campaigns cost a lot of money and because there is a lot of competition from other departments.
(d) Companies do not really measure what people know at a given moment in time—all topics included. As a result, they may arbitrarily decide what should be “topics of the month” or “topics of the year”, rather than focus on topics that need to be learned and retained.

Sales and Marketing issues may include: Product launches, especially if the launches involve disruptive or discontinuous technologies, have little effect on sales people, because information retention is low. Training often takes multiple training iterations, usually in different forms: brochure, formal training, one-on-one discussions, going with the sales person to a customer site, and the like, which can tax the resources of product managers before information starts to sink in. Further, information may be imperfectly viewed and learned.

More recently, the concept of micro-learning has become popular. In micro-learning, users access the training for shorter periods of time. The training is typically administered by computers. Unfortunately, micro-learning can also suffer from some of the issues of conventional training. For example, the material may be delivered in such a way that there is limited incentive to participate regularly and thus may have limited retention and effectiveness. If the material is varied, this can require a large expenditure of time and effort to keep the users involved and interested.

### SUMMARY

There remains a need for an efficient and relatively simple but robust system and method for training, assessment of knowledge, knowledge retention and knowledge reinforcement that attempts to overcome at least some of the above issues.

According to one aspect herein, there is provided a method for training comprising: providing training to a user; testing the user on the training, wherein the testing is performed in short, frequent bursts and continues for a predetermined period of time; and rewarding the user based on results related to the training or testing.

The method for training is intended to be an automated system for training, assessing knowledge, and assisting with knowledge retention and reinforcement. In particular, the provision of testing in short, frequent bursts or pulses over a continuous period of time (rather than a one time test or testing at longer intervals) and in an iterative manner assists with knowledge retention and reinforcement. The period of time may be continuous (for example, during employment in a particular role or the like) or may be set to continue until a goal is reached (for example, a specific performance level is reached or the like). The use of a reward system reinforces knowledge and motivates acquisition and retention of knowledge.

In some cases, the testing in short bursts comprises testing less than approximately ten minutes per test, less than approximately five minutes per test, or less than approximately three minutes per test or lower. Testing in these very short bursts or pulses allows an employee to take the testing without interrupting their day significantly.

In some cases, the testing in frequent bursts comprises testing more than approximately once every week, more than approximately once every three days, more than approximately once every day, or even more frequently. The frequency of training helps to reinforce knowledge.

In another particular case, the testing is adapted to the user based on historical performance to predict areas of required testing. In an automatic system that is adaptive, it is also possible to adjust the testing so that the repetition does not reduce the interest in the questions or testing.

It will be understood that the testing generally comprises one or more questions. The questions may be multiple choice, drop down lists, or any of various types of question formats as appropriate.

In yet another particular case, the rewarding comprises providing the user with a chance to win a prize. This approach makes a game out of the reward process to encourage further participation. In this case, the chance of winning a prize may be adjusted based on user parameters, prize parameters, results related to the training or testing, or other factors. In this way, the game may not be purely random or based on a set of “odds” as would ordinarily be the case in a game of chance. For example, the user parameters may be selected from a group comprising: time last won, prize last won, individual participation rate, individual success rate, absentee rate, job title, line of business, area of activity, or the like. In this way, the chance of winning a prize can be adjusted to drive behaviour with end users.

In some cases, the chance of winning a prize may be based on a combination of user settings and random selection. That is, a user may set the parameters that allow a prize to be awarded, for example, the end user must have a predetermined success rate, but the system then allows a prize to be awarded based on random selection as long as the end user meets the user settings. In these cases, the user settings may include a probability of winning and the probability of winning may be adjusted based on user parameters, prize parameters, and results related to the training or the testing.

In yet another particular case, the rewarding the user is based on one or more parameters related to the user or the program, for example, providing a user with a prize based on user performance. In this case, user performance may include bonuses and penalties related to user or group performance. In a similar way, the rewarding may comprise providing a user or group of users a prize based on the group performance.

In some further cases, the training may also be provided in short, frequent bursts and may also include a testing component. In this way, the training can be delivered in a way that does not take a lot of time and that reinforces the training. If the training itself includes a testing component during the training, the training can be further reinforced. In this case, the training may also be provided based on historical results to predict areas of required training. Thus, an end user that scores low during testing can be provided with a particular training more frequently or the like.

According to another aspect herein, there is provided a system for training comprising: a training module for providing training to a user; a testing module for testing the user on the training, wherein the testing is performed in short, frequent bursts and continues for a predetermined period of time; and a reward module for rewarding the user based on results related to the training or testing.

In a particular case, the testing module is configured to perform testing in short bursts lasting less than approximately ten minutes per test, less than approximately five minutes per test, less than approximately three minutes per test or less time.

In another particular case, the testing module is configured to perform testing in frequent bursts of more than approximately once every week, more than approximately once every three days, more than approximately once every day or more frequently.

In yet another particular case, the testing module is configured to adapt the testing to the user based on historical performance to predict areas of required testing.

In another particular case, the reward module is configured to provide the user with a chance to win a prize. In this case, the reward module may be configured to adjust the chance of winning a prize based on user parameters, prize parameters and results related to the training or testing. For example, the user parameters are selected from the group comprising: time last won, prize last won, individual participation rate, individual success rate, absentee rate, job title, line of business, and area of activity. In some cases, the reward module is configured to adjust the chance of winning a prize based on a combination of user settings and random selection. Here, the user settings may include a probability of winning and the probability of winning may be adjusted based on user parameters, prize parameters, and results related to the training or the testing.

In another particular case, the reward module is configured to reward the user based on one or more parameters related to the user or the program. For example, the reward module may be configured to provide a user with a prize based on user performance. In some cases, the user performance may include bonuses and penalties related to user or group performance.

In still yet another particular case, the training module may also be configured to provide the training in short, frequent bursts and includes a testing component. The training module may also be configured to provide the training based on historical results in order to predict areas of required training.

Other aspects and features of the present disclosure will become apparent to those ordinarily skilled in the art upon review of the following description of specific embodiments in conjunction with the accompanying figures.

### BRIEF DESCRIPTION OF DRAWINGS

For a better understanding of the embodiments described herein and to show more clearly how they may be carried into effect, reference will now be made, by way of example only, to the accompanying drawings which show the exemplary embodiments and in which:

FIG. 1 includes block diagrams the conceptual elements of a system for training;

FIG. 2 includes block diagrams illustrating an embodiment of a system for training;

FIG. 3A illustrates the various modules of the training system;

FIGS. 3B and 3C illustrate a work flow of the method of using the training system;

FIG. 4 illustrates the login process of one embodiment of the training system;

FIG. 5 illustrates the home page functionality according to one embodiment of the training system;

FIG. 6 shows the actions available in some of the training system modules and the link between modules;

FIG. 7 is a table showing the fields of a program template;

FIG. 8 is a table showing the fields of a training program;

FIG. 9 is a table showing the fields of a specific example of a program instantiation;

FIG. 10 is a table showing the fields of a specific example of a training program instantiation;

FIG. 11 illustrates the link between questions and programs;

FIG. 12 illustrates in flow chart form, the method followed by the program launcher;

FIG. 13 illustrates, in flow chart form, the method the program launcher follows to determine a target audience;

FIGS. 14A, 14B and 15 show possible filters to be applied to active questions;

FIG. 16 illustrates, in flow chart form, the method of the question picker;

FIG. 17 illustrates, in flow chart form, the method of the question picker for associating questions;

FIG. 18 illustrates, in flow chart form, the method of the question picker for filtering user attributes;

FIG. 19 illustrates, in flow chart form, the method of associating training questions to training programs;

FIG. 20 illustrates, in flow chart form, the method of the survey question picker;

FIG. 21 Illustrates various scenarios to define program-question or program-pre-quiz compatibility;

FIG. 22 illustrates a training flow for a user;

FIG. 23A illustrates a training flow of an expert user;

FIG. 23B illustrates a training flow for an underperforming user;

FIG. 24 illustrates a user interface for the pre-quiz utility and compatibility checker;

FIGS. 25A and 25B illustrate, in flow chart form, the methods associated with the pre-quiz linker;

FIG. 26 is a table showing fields for a post-quiz gaming program;

FIG. 27 is a table showing fields for another post-quiz gaming program;

FIG. 28 illustrates a user interface for a gaming program;

FIG. 29 illustrates a user interface for establishing a prize group;

FIG. 30A to 30C illustrates a user interface for establishing a prize list;

FIG. 31 is a table showing competition levels for a post-quiz program;

FIG. 32 illustrates the interaction between a post-quiz program and the prize module;

FIGS. 33 and 34 are graphs showing the probability of wining with the ability to modify the probability;

FIG. 35 illustrates, in flow chart form, the method of the prize module;

FIG. 36 illustrates, in flow chart from, the method for determining a prize list;

FIG. 37 illustrates, in flow chart form, the method for determining a win;

FIG. 38 illustrates, in flow chart form, the method of calculating attempt probability;

FIG. 39 illustrates, in flow chart form, the method of calculating time probability;

FIG. 40 illustrates, in flow chart form, the method of picking a prize;

FIG. 41 illustrates the work flow of the report module;

FIG. 42 shows an example reporting page;

FIG. 43 illustrates a user interface for a home page;

FIG. 44 illustrates a user interface for a quiz;

FIG. 45 illustrates a user interface for a post-quiz; and

FIGS. 46 and 47 illustrate a user interface for creating a quiz.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

### DETAILED DESCRIPTION

Generally speaking, the embodiments herein relate to an improved system and method for training, assessment of knowledge, knowledge retention and knowledge reinforcement that is intended to overcome at least some of the problems with conventional training systems.

### Overview

The embodiments disclosed herein are intending to probe a person's knowledge, make learning more interesting and relevant, and also to build a compliance system which may allow for the ability to see who knew what when as well as a personalized, or “predictive” e-learning system. In particular the embodiments described are intended to be used for training, knowledge assessment and knowledge retention reinforcement and could be used in an educational, business or personal setting

Currently conventional training is relatively inefficient because it exposes employees to one idea, one time. Whether the immediate recall is measured or not right after does not appear to make much of a difference: research generally indicates that if a person is exposed only once to a new concept, that person will forget 90% of it after 30 days.

It has been determined that a better way to keep a topic top of mind is to do “interval reinforcement”, presenting the same concept on a regular basis over time. In this case, research shows that with just 6 exposures, 90% of the information is retained over 30 days.

Another inefficiency of conventional training is that training is not tailored to individuals, but rather to groups of individuals. As a result, during any particular training session, there is necessarily an inertia cost of having people sit through a training session, “learning” things they already know or trying to teach them things that are so beyond their knowledge that it is a waste of their and the instructor's or trainer's time

Another problem with conventional training is that it sits outside the flow of operations. People are necessarily taken away from their operational tasks to do training. Either the training or the operation will suffer, because people are expected to learn off the job. The main reason may be training is time consuming and most employees, managers or executives will favor production

Lastly, conventional training is not very reactive, let alone proactive. Training is usually directed to solving problems that have been identified over a long period of time, are seasonal or recurring, but not necessarily the result of new trends, or exceptions. An example: if during the Holiday season, a store sees an unusual level of returns, it is too late for the people who are customer facing and need to know what to do, to be trained on it. Some of them may know, some others will struggle and learn from the ones who know, but in any case, there will potentially be a significant loss in productivity, costly errors and perhaps even customer dissatisfaction.

The embodiments of the systems and methods in this application are intended to address at least some of the issues noted above by:

(a) having questions that are asked frequently (for example, every shift or every day) to employees

(b) having questions that measure employee's knowledge on a wide array of topics

(c) pools of questions tailored to an individual, based on their profile and attributes (what they do, where they work), their knowledge map, etc.

(d) quizzes taking an average of <2 minutes approximately every 1 to 5 days to complete the questions

(e) keeping employees engaged by organizing competitions, quizzes and games that are embedded in the training or knowledge retention programs

(f) streamlining the program creation workflow so that many different programs can be created to address specific training/communication needs, pertaining to different departments (safety, loss-prevention, operations, marketing, HR for instance), different job titles, different geographic areas, etc.

(g) streamlining the questions creation workflow so that subject matter experts (SME's), or others, can enter content into the platform and see it reach the right people, on the right occasion, right away

(h) calibrating the characteristics of the questions, regardless of the program, to an employee's attributes, including status (new, active, inactive, etc.) and the like.

The systems and methods herein are intended to be a configurable, autonomous base for allowing administrators to configure the training method and systems.

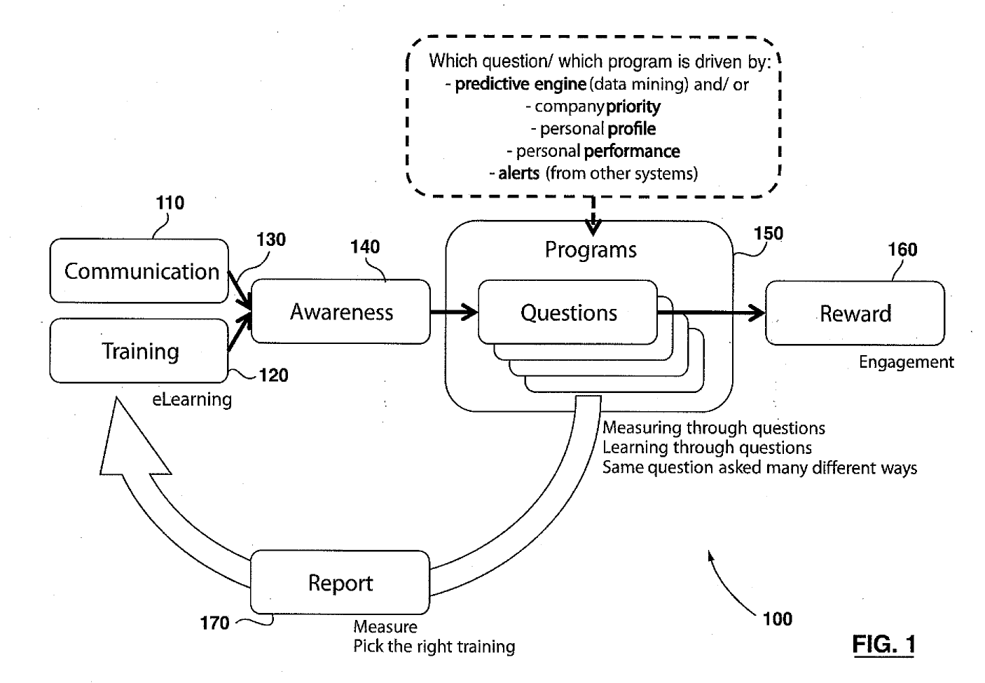

FIG. 1 shows an overview of an example system 100 for training that makes use of micro-learning and e-learning techniques and incorporates adaptive training. The system includes the development of communication 110 or training 120 goals, the delivery 130 of these communication 110 or training 120 goals to create awareness 140, and the testing of the awareness via question or quiz programs 150. In some cases, the results of the testing may provide for rewards 160 to the users based on their awareness or the like. The rewards 160 are provided to encourage engagement with the system and intended to drive additional participation and knowledge retention. In the system 100, the results 170 of the testing 150 are also fed back into the communication 110 and training 120 goals so that the training 120 or communications 110 can be adapted and fine-tuned to meet any shortfalls detected by the quiz or question programs 150. The particular quiz and question program and, in fact, the questions within the quiz and question program can be selected by a predictive engine (that is, adapt the program or questions based on past experience) that can make use of company priority, personal profile, personal performance, alerts, or the like as described in more detail below.

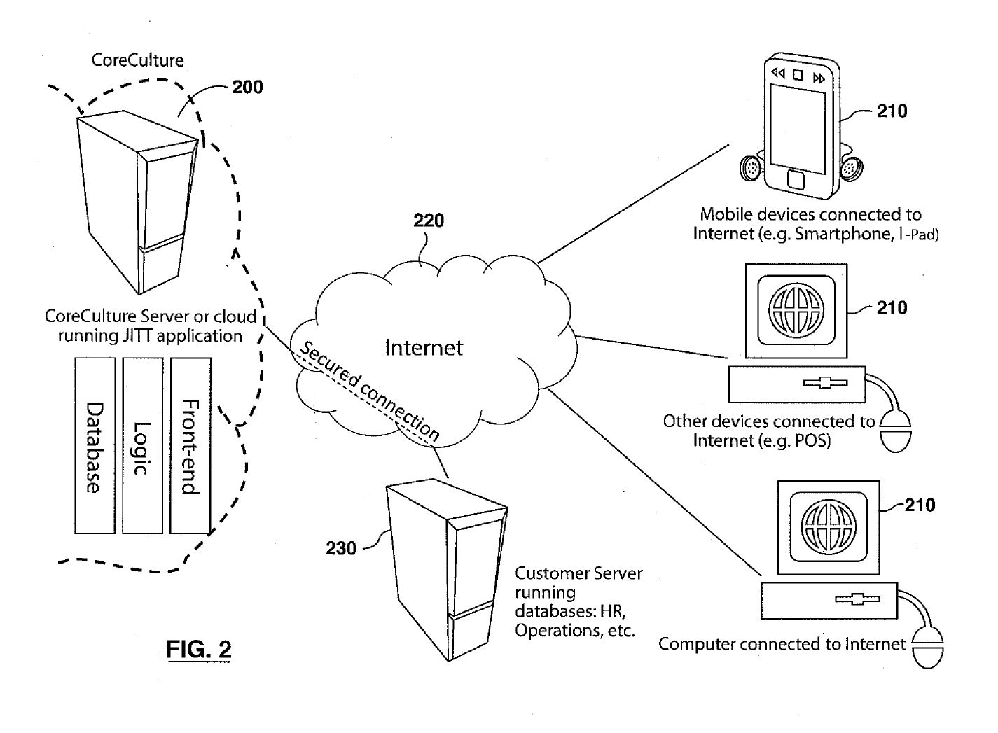

FIG. 2 shows an overview of a physical environment for an embodiment of a system for training. The system includes a server device 200 that handles the provision of programs and the like and one or more client devices 210 that communicate with each other via a network 220. In particular embodiments, there may be a plurality of servers 200 as well as a plurality of clients 210 or client devices including mobile devices or smart phones. Further, there may also be a customer server 230 or end user server that provides data on end user information, preferably via secure connection, to the server device 200. The server 200 and clients 210 may be general purpose computers as are known in the art or may be devices designed specifically for the system for training or for another purpose that can also be used to provide training. In other embodiments, the server may be a secure cloud. The network 220 may be a local area network, a wide area network, the Internet, or the like.

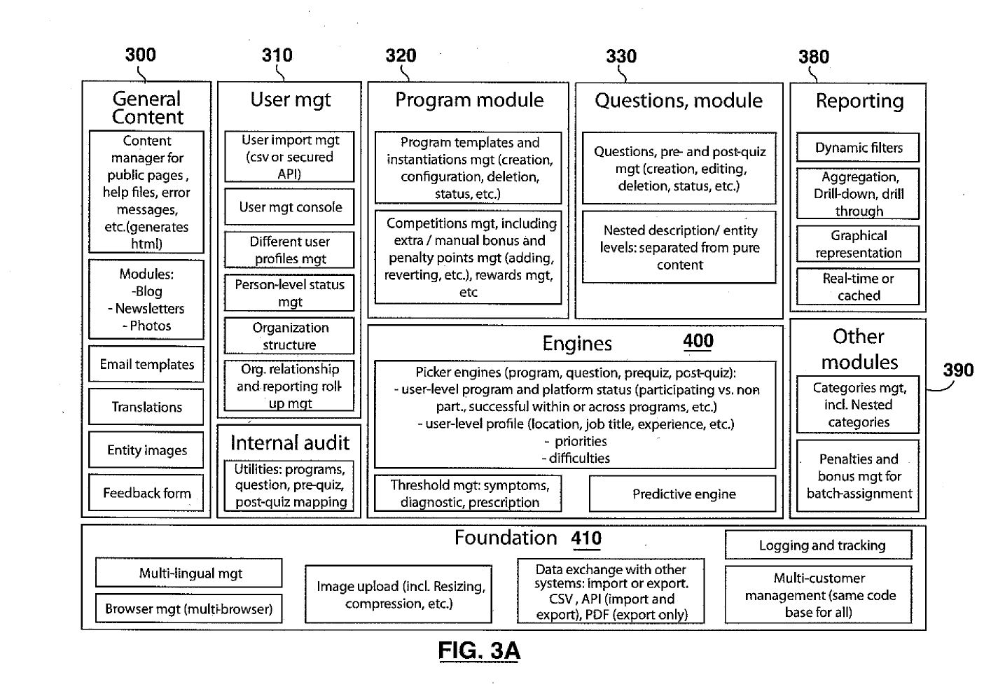

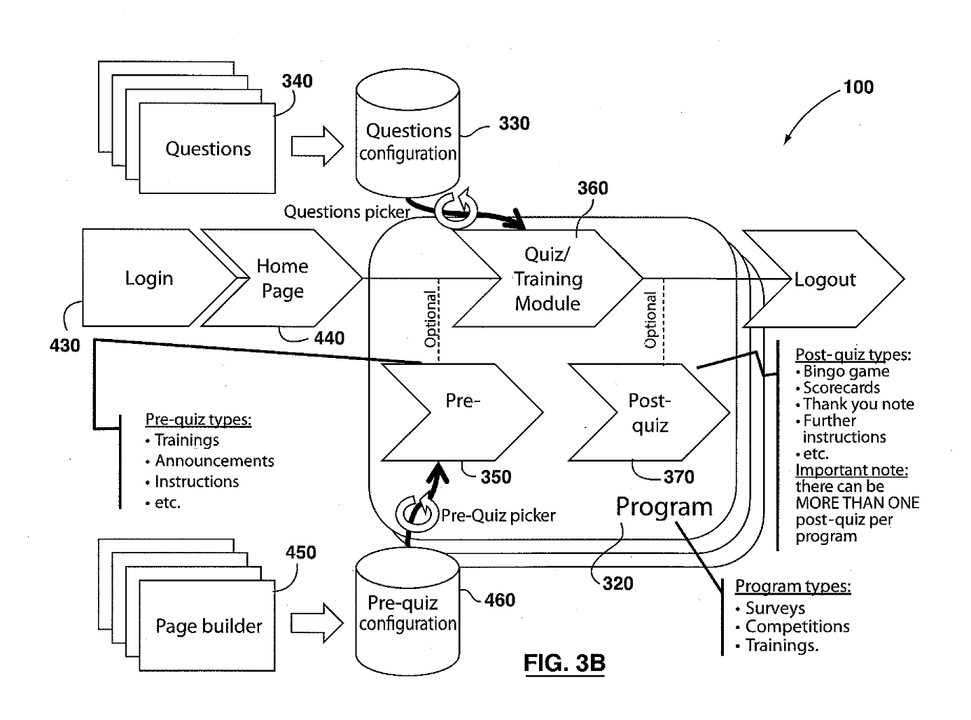

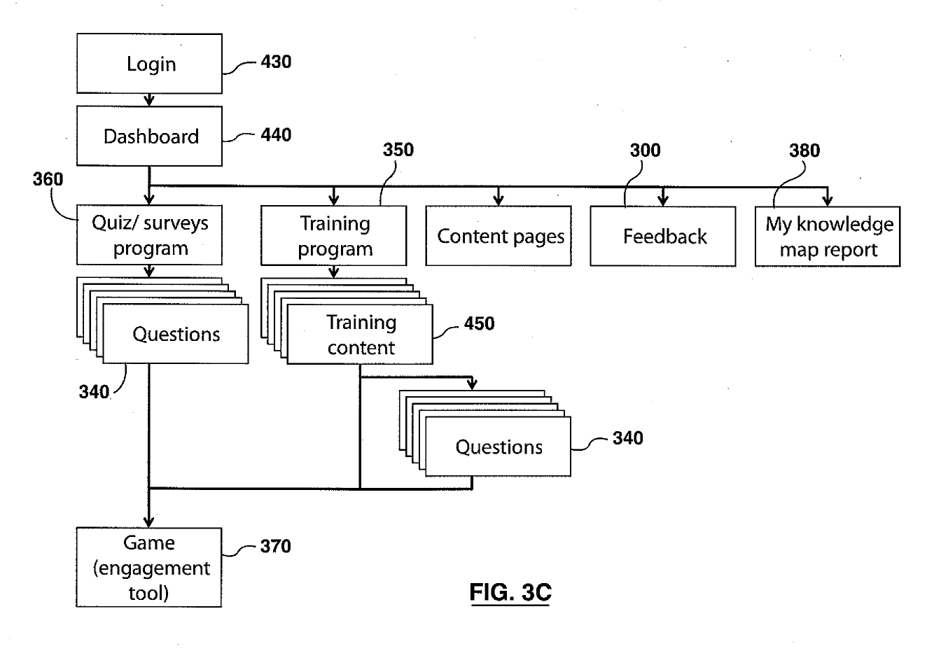

FIG. 3A shows a block diagram showing several components of the training system 100 of FIG. 1. FIGS. 3B and 3C further illustrate an overview of the workflow, and a simplified model of the interaction between the components shown in FIG. 3A. The training system 100 includes a general content section 300, which may include, for example, content management, blog and newsletter modules, and translations. These features may be optional and are described in further detail below.

The system 100 also includes a user management portion 310, where users (sometimes referred to as associates or employees) are categorized, a program module 320, which may include program templates and instantiations and competitions management. Other modules may include question modules 330, which may include pre-quiz and post-quiz questions 340 for a pre-quiz 350 module and a quiz module 360. The post-quiz module 370 includes rewards and penalties relating to the program module 320. The system 100 also includes a reporting module 380 for generating real-time and historical reports. The logic flows and other utilities may be further included in other modules 390, or in the engines 400, foundation 410 and internal audit components 420.

FIG. 3B shows further details of an example workflow that expands on that shown in FIG. 2. Various aspects of the workflow in FIG. 3B, and in particular the various configurations for the various programs are explained in more detail below. A user logs on 430 the training system 100 and is presented with a home page or user interface (UI) 440. The home page 440 may display a variety of options such as: pre-quiz programs, for example, training programs or surveys; quiz programs; or post-quiz programs, for example a gaming or prize module or follow-up survey.

As seen in the FIG. 3B, a program may include training and pre-quiz programs or components 350, quiz programs or components 360, and post-quiz programs or components 370, or other aspects such as surveys or a company blog. These various programs may be designed using templates provided in the program module 320 or program template module, and each specific training program or quiz may be an instantiation of a program template. For example, a training module may be designed in a page builder 450 and configured by the pre-quiz configuration 460. The page builder 450 feeds content into the pre-quiz module 350 through a pre-quiz linker, which matches the pre-quiz configuration 460 to the program 320 configuration. Program templates may be standard throughout multiple program instantiations, or may be created specifically for a single program.

FIG. 3C illustrates a second example layout of the workflow or modules of the training system 100. Questions 340 feed quiz 360 or survey programs as well as training programs 350 via a question picker, which matches the question configuration to the program configuration. A user may also have options to see other general content 300 from the home page 440 such as feedback forms or reports generated from the reporting module 380. The general content 300 may be general purpose pages to display information to all or some associates, for example a new policy or new campaign.

The training system and methods are intended to add a new dimension to conventional training. The system may also include a knowledge “audit” tool (not shown), administered by, for example, the program management component, with an empirical and non-invasive learning component. People learn through the questions that they are being asked, and their retention level may be higher with use of the training system and methods.

In a specific example, as shown in the work flow of FIG. 3B, a user may login and a training program may initiate a training module as a pre-quiz component that might include 2-5 slides and it may be followed by a quiz component of a series of 3-5 related questions following the training slides. As shown in FIG. 3B, this quiz module 360 may optionally be followed by a post-quiz, such as a scorecard or other type of post-quiz information. As noted herein, the training system makes use of a question picker that works with the question configuration module to influence the types of questions and, in some cases, the way questions are asked to associates, which are intended to validate the outcome of the training.

In one context, the training system 100 may include a predictive learning component that encompasses various aspects within the system. In particular, the aspects of pre-quiz, quiz, post-quiz, programs and questions, provide predictive or adaptive elements to the system:

Questions 340 are configured in the question module 330. Questions 340 may be categorized by a plurality of parameters and may be appointed explicitly to one or several programs or associated to programs that match the question category configuration. Through the questions picker, the questions are chosen in an adaptive way based on a plurality of parameters, such as end user history, question frequency, question priority, and the like.

Training modules may be encompassed in a more general module—the pre-quiz module 350. Pre-quiz elements could also be announcements, instructions, etc. The trainings may be internally developed training programs or may be externally provided or linked trainings, for example, Sharable Content Object Reference Model (SCORM) compliant trainings. The trainings may be appointed explicitly to a (or several) program(s) or associated with programs that match specific categories configuration, through a pre-quiz linker. To make the configuration easier, a page builder component, which would allow administrators to put together most pre-quizzes without any development intervention and customization, may be included.

A quiz module 360 provides a quiz that may be a series of questions. A quiz program may be asked within the context of the program. A program may be on a specific topic, targeting a specific group in the company or may be completely generalized. As noted herein, the quiz module may be preceded by an input or an introduction (pre-quiz) and/or followed by a validation or another series of instructions (post-quiz).

After a quiz, there may be post-quiz activity such as a validation, a reward: of a scorecard, a reward, such as a Bingo card, a game of chance, a rally map, etc. These validations could also be further instructions, tips or a thank you note. These are all encompassed under the term “post-quiz” as they are more likely to come after the quiz. The post-quizzes are also configurable by administrators.

A program is generally defined as an entity that incorporates pre-quiz, quiz and post-quiz modules. The link between these modules or components can be explicit (for example, designating a specific pre-quiz) or assigned by association through the configuration, pre-quiz linker, questions picker or the like as explained herein. This configuration may allow the system to have a range of pre-quizzes available for any given program, which would allow a variation of pre-quiz to users who are subject to the same program. Similarly questions asked in the quiz would follow the same dynamics: either assigned specifically to a program, or chosen by association of categories through the question picker. Programs may be created through a sequential process, which includes the creation of a program template that provides the main framework of the program. The program template may be instantiated (program instantiation) as many times as needed.

The training-related questions 340 may be analyzed by the system (saturation rate, success rate, category analysis) such that reports may be generated, as explained below.

The training system and methods are further described below with reference to a specific embodiment. In this embodiment, end users are employees (also called associates) of a large retail chain. Some associates may be managers or supervisors while others may be administrators of the training system. Various roles will be described with reference to these titles, although it should be understood that any user may have a variety of responsibilities and options under the training system.

In the particular embodiment described below, the training system is used for safety training. It will be understood however that the system is intended to be built to be sufficiently robust to allow configuration to address other areas of training within the organization.

The embodiment makes use of the workflow for the training system provided in FIGS. 3B and 3C.

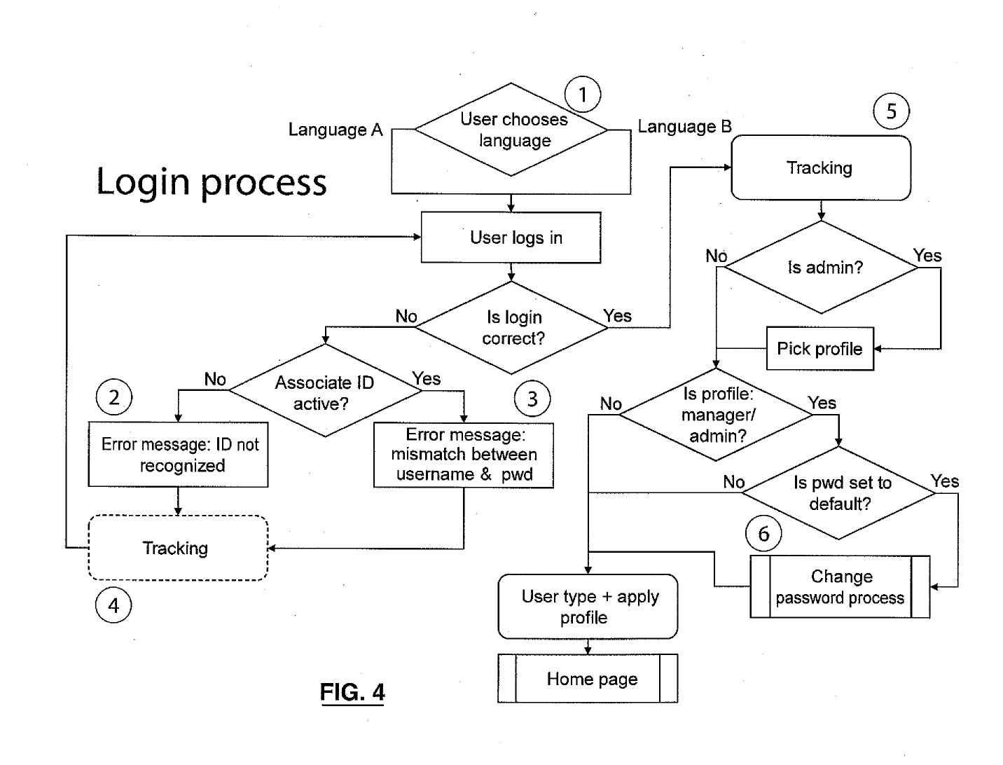

The front end workflow reflects what the associates see when they log into the system. The login process is illustrated in FIG. 4. It is supported by all the back-end functionality, further described below.

It will be understood that the login 430 is intended to be flexible and a manager may not see the program and may go directly to reports, whereas an employee may be directed to a separate home page. In one embodiment, the system may be bilingual in English and Spanish or multilingual in a variety of languages. Tracking of logins may include tracking: ID, date/time, browser, IP address, language selected and/or password. When reporting, the system may aggregate the count of logins from the individual all the way up to company level.

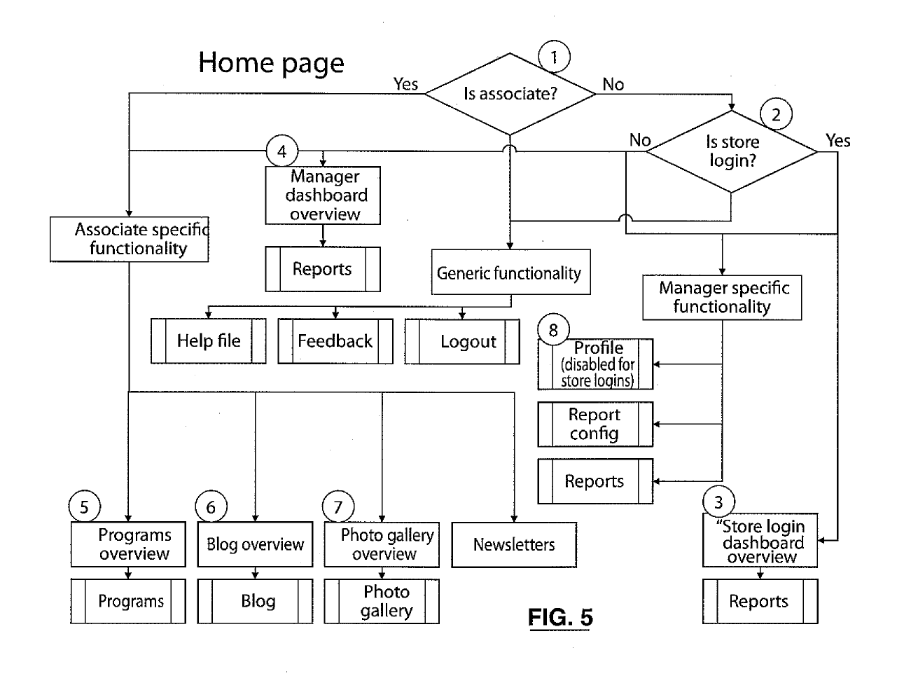

Once logged in, the user will be directed to a home page, sometimes called a dashboard. Depending on the type of user, the homepage presented may vary. Example components of the home page are illustrated in FIG. 5. A home page may include, for example, on-going programs, possible reports of interest, specific user statistics, etc. Home pages may also have access to generic functionality such as help files, feedback, logout, etc. Home pages will generally display information, for example, program instantiation title, description and subject; the user's points accumulated or any penalty points accumulated, last winner information etc. Also the general content pages may be used for such things as recent newsletters, company blog, and other operating procedures.

The store manager or admin users may also have the ability to access additional data, such as: corporate login statistics; relevant division and/or area statistics if applicable; or statistics of stores nested in areas.

In particular, the home page allows the end user to begin a particular program instantiation and start answering questions or complete the pre-quiz.

It will be understood that before use by end users, the system must first be configured and initialized. This initialization involves populating the information for user access and for initial programs.

Once initialized, data is also intended to be updated regularly. For example, updates of employee login information, questions module, and the like can be imported. In some cases (for example, reporting), the system also needs to be configured to generate and export files.

As shown in FIG. 2, the import and export of some data may be between a system server and customer server via a secure link. It may be preferred that customers run the training systems on a local server or a server remotely hosted. In one case, the remote host may host the server or a cloud and provide the IP address of the server.

In this particular example, imported information may include various fields of relevance including information on the user, the user status and location within the organization the user belongs to for example, works in a store or in the accounts receivable department. It will be understood that various types of information may be available and useful. Further, the system will require a process for handling conflicts between data sets. The system may also include the ability for manual entry of data.

Further, the alternation of data may have implications on the way the programs are run and implications for example, on the winning rules for the current post-quiz games.

In one example, user types may include, for example:

Store associates who would be participating in various program instantiations;

Store managers who would be participating in various program instantiations with the ability to run some reports;

System administrators that may log into an admin console; and

Other users: anyone not belonging to either previous categories

User rights may depend on a user type matrix. The user types matrix may determine which role is allowed to do particular tasks or to view aspects in the system. User type configuration module may also be included in the system. An additional module could be built to allow the matrix to be configurable by administrators, system administrators or by a super user to the system.

### Programs

Programs are intended to encompass the elements of pre-quiz, quiz and post quiz, sometimes referred to as training, quiz or questions, and post quiz. In this embodiment, the structure is set such that the elements can each be prepared as a generalized template and then various instantiations of that template can be created. For example, each program instantiation may be directed at only a target audience matching parameters set during the design of the program instantiation. Program templates and instantiations will typically start on a company-level and as findings start to emerge, they can be tailored per area, per Line of Business (LOB), per job title, etc. There might be on-going programs, and others that are focused one-month long campaigns to draw attention to a specific issue.

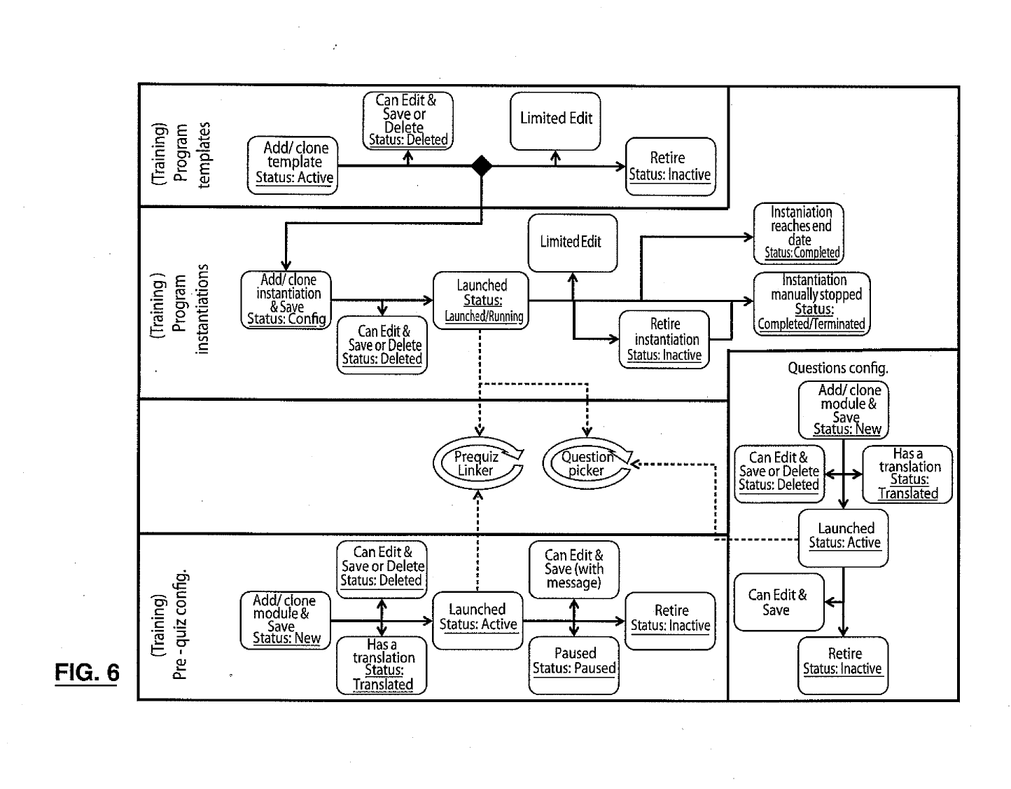

FIG. 6 illustrates the relation between program templates and program instantiations as well as the pre-quiz and question configuration with reference to the question picker and pre-quiz linker.

Program templates may contain information that is carried through to all programs that stem from them and hence allow the creation of programs faster as there may be less repetitive information to fill in. Further, program templates are intended to allow programs to be sufficiently consistent to be comparable over time, for example, program templates may allow numerous programs to be running in parallel and be more manageable than if each program had to be managed individually.

There may be one or more levels of program templates. For example, if there is only one level of program template, there may be different templates for each campaign, for example, “Shop safety”, “Hazard materials—Chemicals—proper handling of chemicals”, etc. and each period, yearly campaign compared to monthly campaigns.

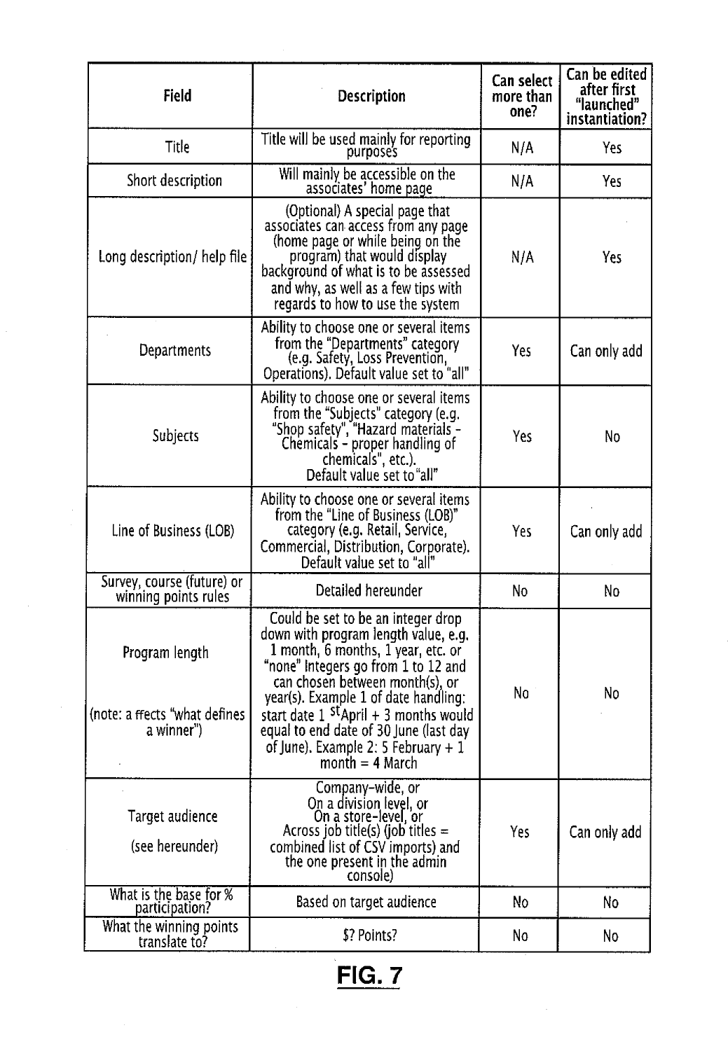

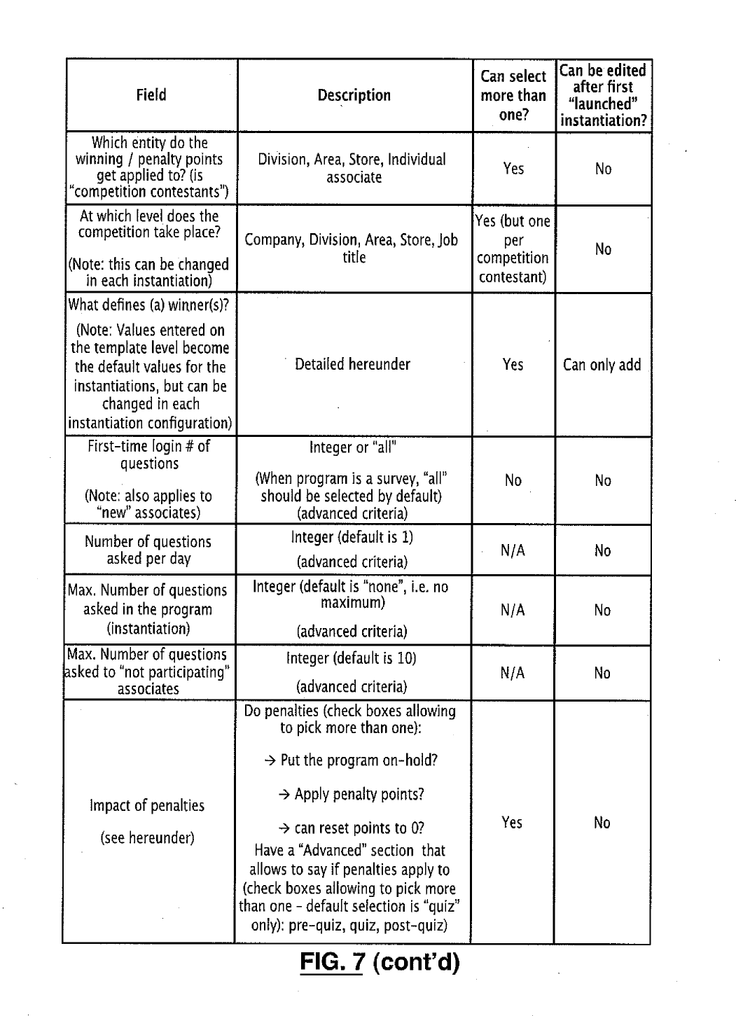

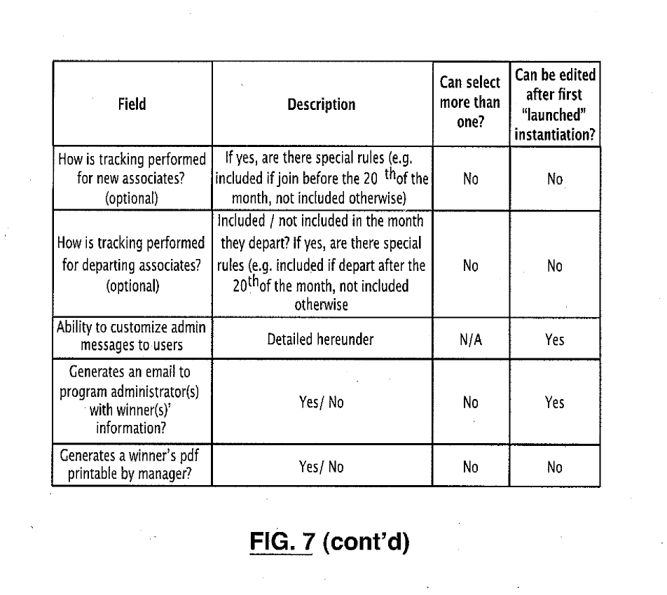

FIG. 7 is an example list of fields in templates.

Target audience is used to define the entities to which the program may be addressed. If “area” is selected, all associates working in those specific area(s) will be submitted to the program. If “job title” is selected, all associates holding (a) specific job title(s) will be submitted to the program. If both are selected, there will be the opportunity in the instantiation to pick (a) specific job title(s) in a specific area.

The ability to customize admin messages to users may allow administrators to enter free text messages for all messages that may show in the course of the program template.

A program template may include a survey with no right answer and hence no winning rules or multiple choice questions. If the program template includes the winning rules option, instead of a monetary value, there may be a points system, which may allow the freedom to translate these points either in cash prizes, other prizes, miles, etc. Winning points may be awarded on many parameters or bases, predetermined by the program instantiation, for example, points for days without penalties, for questions answered, for correct answers, etc.

The table below illustrates example options, which can be used to determine a winner of a program. Entities may be any of those picked in the ones to which winning/penalty points are applied and any other options may be combined.

| | options |
|---|---|
| Requires that | Top X (nb of entities) with the highest points (or dollars |
| there is an | whichever was chosen in “what winning points translate |
| end of | to?”) by the end of the program per Z entity (note that the |
| program | entity on which the competition happens needs to be |
| where the | strictly hierarchally higher than the entity to which the |
| count can be | winning points are awarded. If points are awarded to |
| performed | individual associates, Z can be a store, an area, a |
| | division or the company; if it is an area, Z can only be a |
| | division or the company) |
| | Top X (nb of entities) with Y % participation |
| | Top X (nb of entities) with Y % success rate |
| | (correct answers) |
| When | First X (nb of entities) with Y % participation (which, if |
| reached, | set at 100%, would be the same as first X (nb of entities) |
| ends the | to complete the program) |
| program | First X (nb of entities) with Y % success rate |
| automatically | (correct answers) |
| (optional) | First X (nb of entities) with Y number of points/dollars |

Values entered on the template level may become the default values for the instantiations, but can be changed in each instantiation configuration. As a specific example: a program template may choose to reward individuals participating in a store as well as creating a competition on store level throughout the company. In this case, the parameters may be as follows:

the target audience selected would be: stores;

entities to which winning/penalty points are applied would be: both stores and associates;

the competition level would be: “company” for the stores and “store” for the associates; and

the winning rules could then be set to: at the end of the program, reward the top 1 associate with the highest number of points in a store, AND the top 20 stores company-wide with the highest % participation.

Adding a program template is intended to be straight-forward. After a program has been instantiated, some fields may not be editable as it might then skew the reporting. Some other fields may accept new entries, but may not accept changes to entries that are used in instantiations. Some fields may accept changes entirely.

For example, assume that a program template is set to be a monthly campaign applied to store managers in the retail side of a large retail store. Its success is such that Distribution Centers want to adopt it as-is for their Distribution Centre managers. The title as well as the short- and long-descriptions of the template could be slightly amended to include Distribution Centers, the Line of Business (LOB) field may accept “distribution” to be added (but not to take “retail” out, as some instantiations rely on it), etc. An instantiation for the Distribution Centers may then be created from the template. The Distribution Centers can then change the winning rules, the program length, or the base for % participation, can do so in an instantiation or alternatively clone the template and create a separate template. The later approach may be more appropriate as changing these aspects may make any comparison between the programs inaccurate.

For a user, training programs will typically look like any other program that will appear on a dashboard or home screen. For an administrator, the setup of training program templates and instantiations will be very similar to the setup of quiz or survey programs.

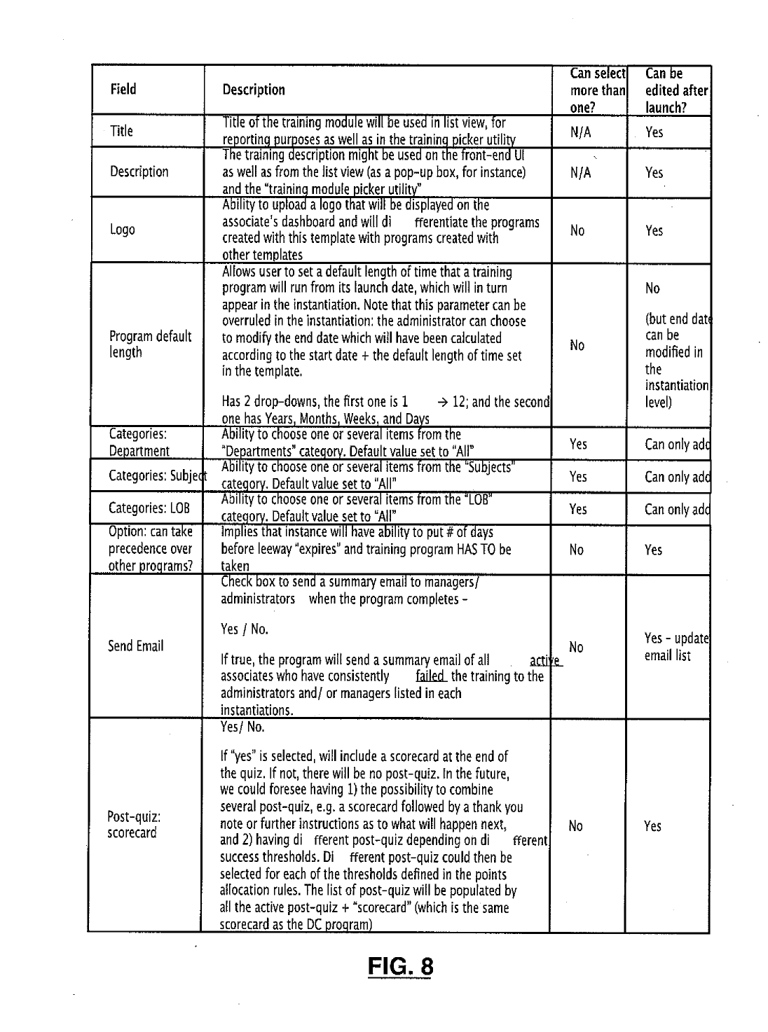

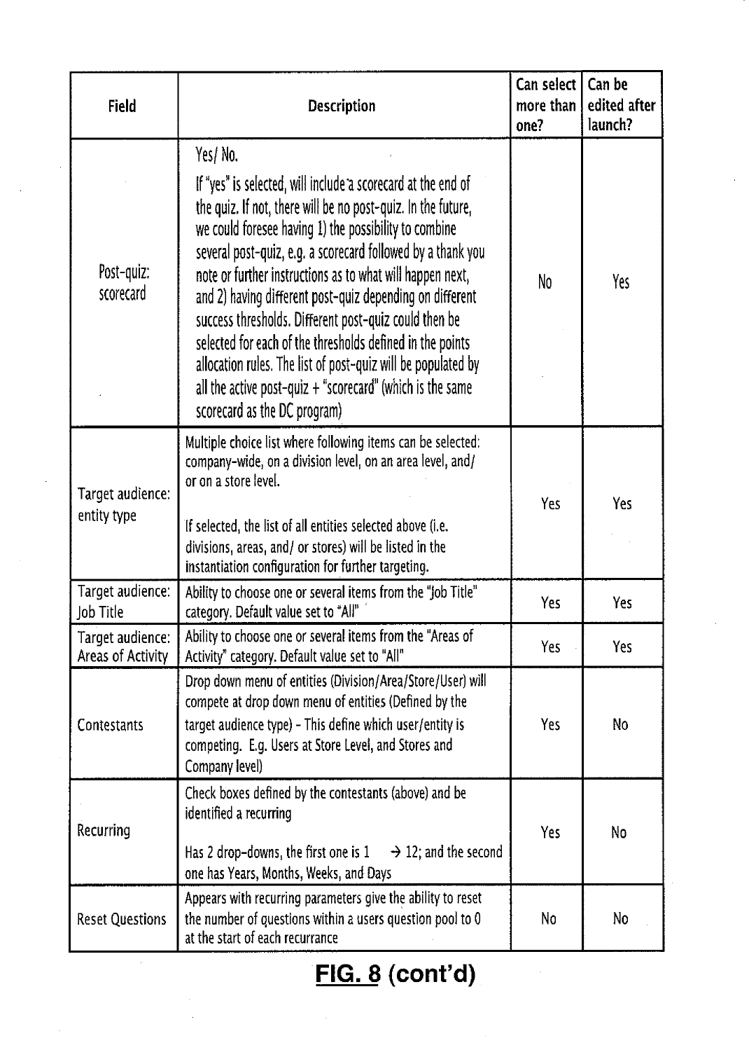

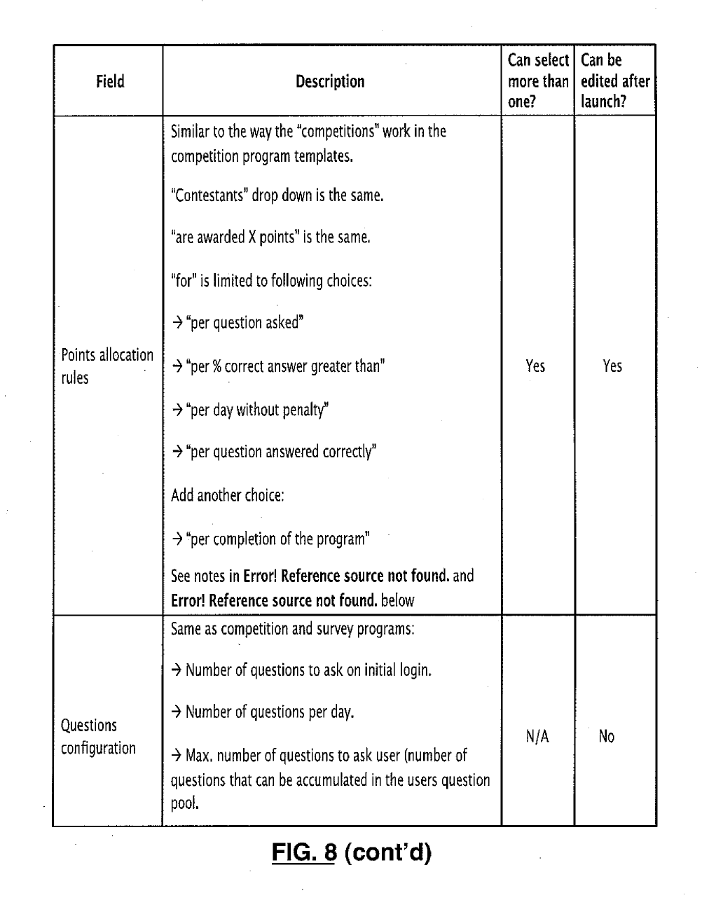

FIG. 8 provides example training template fields. Unlike quizzes, the participation level may not be based on number of questions answered, but rather whether a training program was completed or not. The number of questions per training, per pre-quiz, may be on a program level or on a pre-quiz level.

Training programs, unlike most quiz programs, are intended to be temporal programs that may be one-time or may be recurring, for example annual harassment policy training. These programs may not carry on over time: they may be offered on a need-basis and once they are completed, they may be withdrawn from the employee's dashboard, until a new training program is assigned to the employee. Survey programs may follow the same paradigm. For training programs, there is a need to have a status indicating that, beyond participation, an employee has completed a program. If the employee takes a quiz without completing it, he/she may still be participating.

One component of a program may include an admin user interface in the program template configuration. The admin user interface may show:

Participation rate/Success rate: calculates an aggregation of success rates of all instantiations or perhaps of grouped templates. This could provide a link to a program report which could include the potential to drill down through instantiations or the like.

User comments: displays the number of comments that users have sent about instantiations, perhaps also with drill down capability.

Instantiations are intended to be more flexible than templates, since no other items may depend on them except perhaps for questions selected by the question picker.

The idea of instantiations is that they allow the system to narrow down the criteria set in the templates. For example, if stores were chosen to be the recipients of the program in the template, the instantiation indicates which stores specifically (or all stores) should take the program. Similarly, if the program length was set to one month, the instantiation may determine which month the program will run.

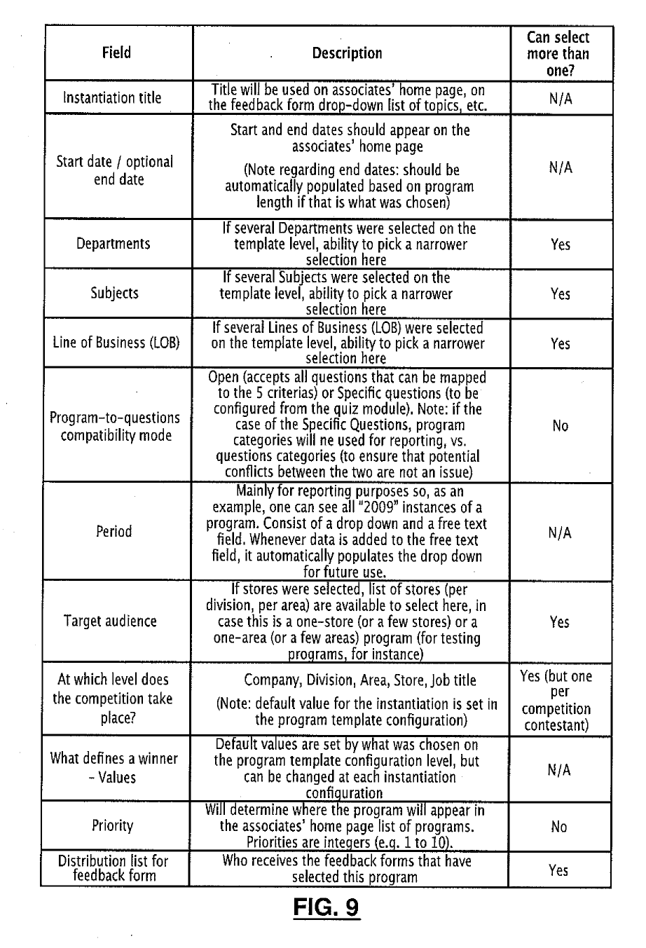

Instantiations workflow may include, for example: Add/clone instantiation (becomes “new”); Edit or delete (becomes “deleted” if deleted); Launch (generally cannot delete after launch) (becomes “launched”); Running (after launch but prior to completion) Terminate instantiation (which makes it inactive); and Completed if it has reached an end date (or manually stopped if stopped and has no end date). FIG. 9 is an example of a proposed list of fields for a program instantiation.

In a template or instantiation, there will typically be a pool of active questions that are selected for an end user during the running of the program based on a number of factors. The training system may be configured with a utility that calculates the number of active questions or pre-quiz training modules for a program instantiation before it is launched. The general rule may be that the number of questions asked are a combination of:

One question per day (independent of games start and end dates);

Number of questions asked are a combination of associate's status+last login date+pool of questions that remained to be asked in associate's last session; and

Questions may be grouped in such a way that the questions rated with a higher importance level may be asked first and more frequently than lower rated questions.

Similar to question/quiz templates and instantiation, training program instantiation may use the configuration of the program templates as a reference and further filter data to adjust the target or the competition to better match the goal of a program.

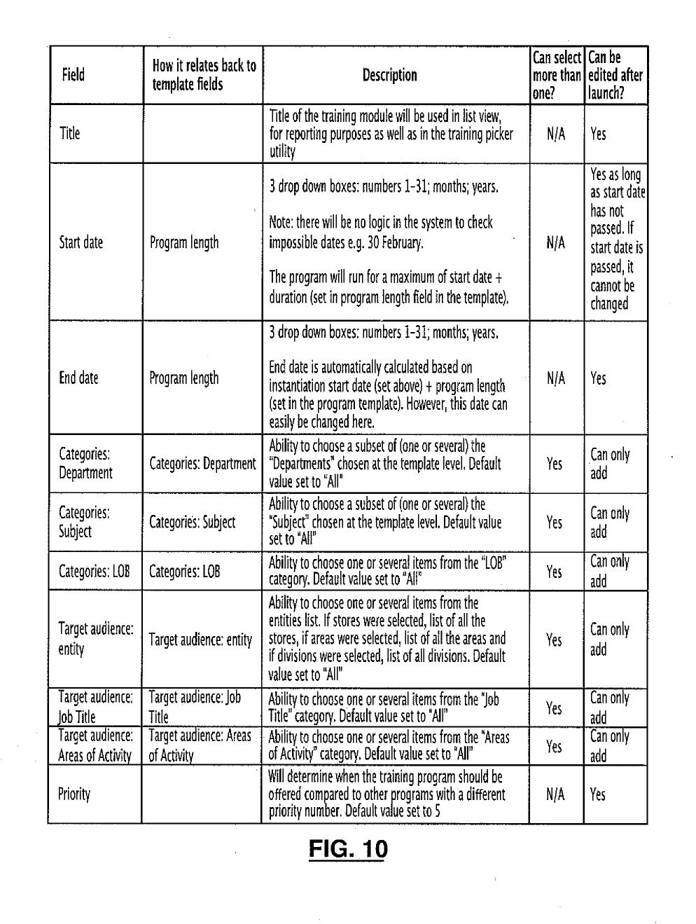

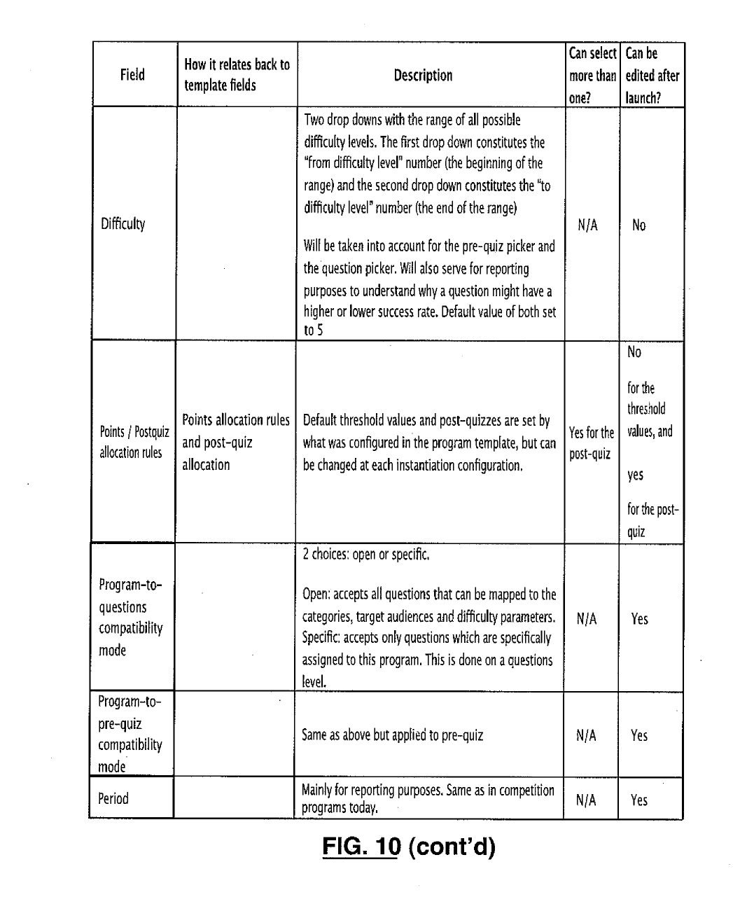

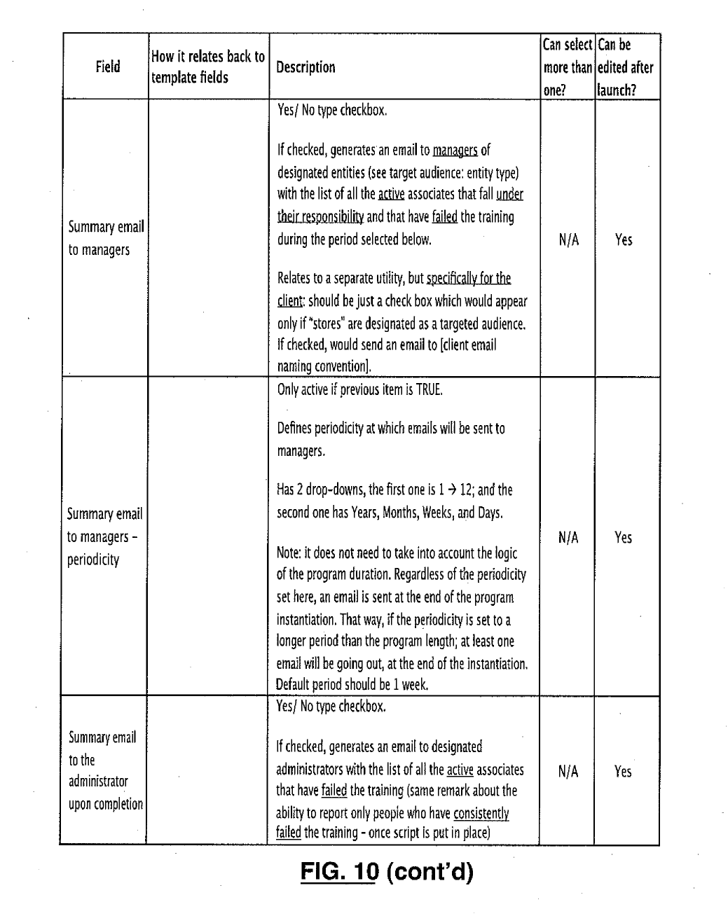

FIG. 10 illustrates an example of training program instantiation fields. In particular, the training may be configured to be offered on an individual basis, depending on the knowledge the associates have demonstrated in a specific field. For example, in one case an individual demonstrates a consistent weakness in Fire Safety (difficulty 2), a Level 2 Fire Safety Training will be offered to this individual.

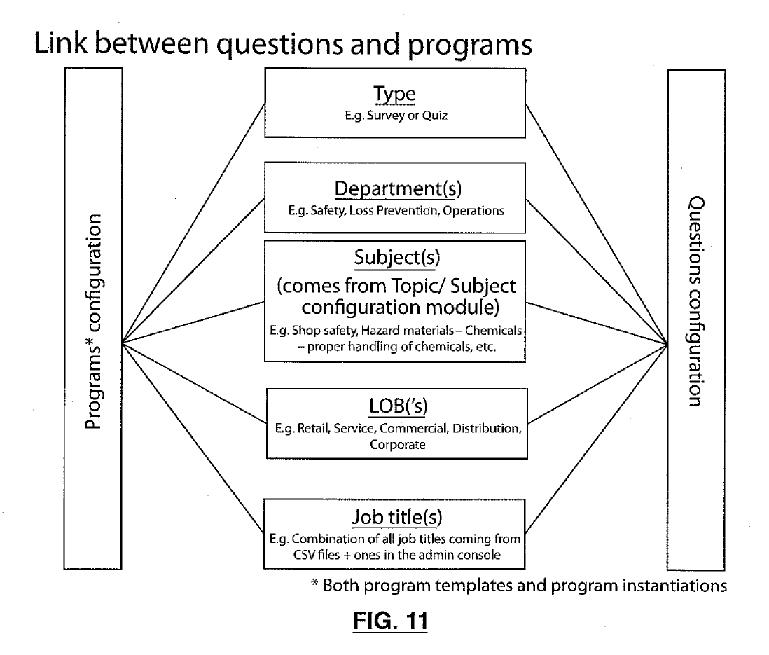

As explained above, questions are intended to be automatically selected for particular programs (templates or instantiations) and then further selected with regard to end-users. FIG. 11 illustrates the relation among and some of the possible linking between programs (templates or instantiations) and questions. The scenarios that follow apply to specific program instantiations, which may be in an open mode where the training system will automatically assign questions and/or pre-quizzes to program instantiations.

In one particular example, further parameters for programs and questions may be added: for example, Difficulty and Area of Activity. Having a range of parameters allows question selection into a program instantiation and subsequently applied to an individual to be adapted and modified for a wide range of scenarios. The system may use a question that encompasses most or all parameters in most or all of the categories of a program to be associated with it. In another embodiment, selection changes to allow at least one item in each of the parameters on program level and then on associate level. A question or pre-quiz may hence be selected in a program and never be submitted to an associate, if no associate corresponds to its specific configuration.

In a specific example, a program instantiation may be configured to be a SAFETY program (all types, all departments, and all subjects) and assigned specifically to job titles: “cashier” and “customer support”. All questions which include department or line of business (LOB): “safety” and either or both job title “cashier” and “customer support” may be included in the program (regardless of the other parameters as all other parameters for this program may be all inclusive). For example:

If a technician logs in, he/she will not be selected in the program; or

If a cashier logs in, he/she will have the ability to log into the program. He/she will then see pre-quiz and questions that have been included in the program that incorporates department: “safety” and that encompasses, among others, job titles “cashiers”. If there are pre-quiz or questions that were selected into the program because they include department: “Safety” and job title: “customer support”, they would NOT be presented to a cashier.

In another particular example, a Safety program is assigned to store and service managers. Store managers will be enrolled in this program. They will only get questions which indicate they are, specifically or among others, to be taken by store or service managers and which are, specifically or among others, Safety-related questions.

Another specific example of a program, focusing on Loss-Prevention and Safety is assigned to store, service and distribution centre managers. A question which is a Safety-only question for DC managers may nevertheless be enrolled in the program and be offered to DC managers (but to DC managers only).

As a further example, a program, focusing on Loss-Prevention only is assigned to store, service and DC managers. A question which is a Safety-only question for DC managers will NOT be enrolled in the program and therefore NOT be offered, even to DC managers.

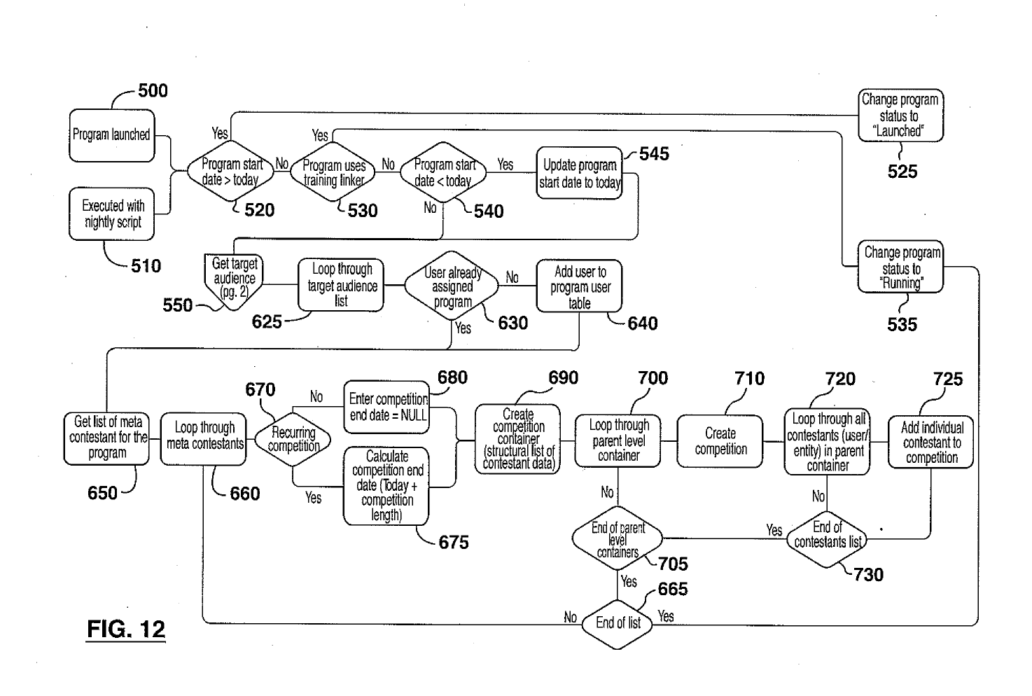

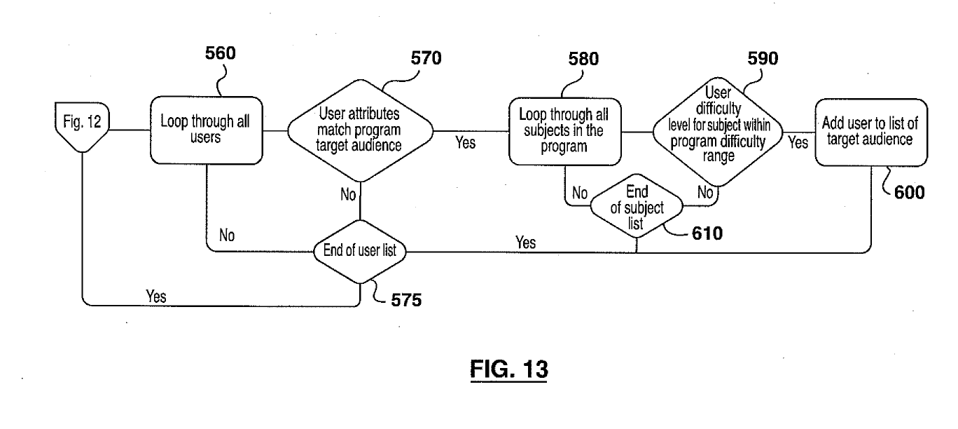

Once the programs and questions have been created and configured, a program launcher is initialized by the training system. FIG. 12 shows a flow chart for the program launcher module. Generally speaking, there are two times when the program launcher is executed. 1) After the configuration of a program to enable it to run within the system 500 and 2) after each update of employee or other data that may impact the program. In this particular embodiment, the program launcher is run each night with a nightly script to update data 510.

The start date is compared 520 with the current date to determine whether the program should be “launched” status 525 or is ready to be moved to a running status 535. The program may connect to a pre-quiz linker 530 as further described below and change the status of the program to “running” 535. If the program does not use the pre-quiz linker, the program launcher will determine which users should be assigned the program and other program parameters. As the program may be a quiz or other non-pre-quiz activity, it may not need to interact with the pre-quiz linker.

If the program is not running and the start date is less than the current date 540, the start date will be updated to the current date 545 and the program launcher will determine the target audience 550 based on the flowchart in FIG. 13. To determine the target audience, the program launcher will loop 560 through all available users.

First the program launcher will loop through all users to see if any user attributes match 570 the predetermined target audience parameters of the program. User attributes may include various parameters, for example, job title, area of activity, length of employment, experience level or proficiency level overall or by subject or task, personality type, preferred learning manner, or character type. If no users match, the target audience will return an empty list 575. If the user attributes match, the program launcher will loop through 580 the subjects associated with the program, if any have been associated. For associated subjects, the program will determine the difficulty range 590 of user with matching attributes. If the user has a difficulty range within the program's difficulty level for the associated subject the user will be added 600 to the target audience or user list. The program launcher will review 610 these parameters for each user that had matching user attributes to the program.

Now that the target audience has been determined, the program launcher (FIG. 12) will loop through 620 this target list to determine which users are already assigned to the program 630 and which users are new and need to be assigned 640 to the program. Once the user list is complete, the program launcher retrieves a list of the meta-contestants 650 for the programs by retrieving the various competitions that may be associated with the program. Although some programs may not have competitions per se, as users are still assigned to these programs the meta-contestants can be thought of as competitions without winners.

The program manager will loop through 660 the metacontestant list per competition being held. First, the program launcher will see if the competition is recurring 670, if it is the program launcher will calculate the end date 675, which may be to determine the start date as the current date and add to that the competition length. It will be understood that the competition length may not be equal to the program instantiation's running time as a competition may occur several times within a single instantiation. If there is no end date the program launcher will enter 680 a null value as the end date. Next the program launcher will create a competition container 690 which includes the structural list of contestant data, for example the competition may be for users at a store level, so the container would include all users within each store.

Once the container has been created, the program launcher will loop through 700 the parent level container, for each recurring competition 705, and create a competition 710 by looping through the contestants 720 in the parent container. The individual users will be added 725 to the competition and a competition will have contestants at each parent level container, for example if the competitions is per users at a store, the users within the one store will be in the same competition and a competition will be created for each store within the company, a particular example is described below. Once the program launcher has completed user assignment 730 and competition creation the program status is changed to running 535 and can be accessed by users logging into the system.

In a particular example, a program is configured using the following parameters: start date tomorrow, assigned to all users within the west division without using the linker. The program is specific to the subject of Safety with difficulty level 2. There will be two competitions, a monthly competition between all users in a store, and a quarterly competition between all stores in a division.

Once the configuration on the program is complete, the launch button is selected. The program launch code is executed. The program launcher would change the status to “launched” because the program start date is >current date and end. That evening (after midnight), the nightly script would run on the program a second time. The start date is no longer >current date so the code would continue. The program does not use the linker, and the start date is not <the current date, so the code continues to retrieve the target audience for this program. Looping through all active users, it identifies all users within the west division with a difficulty level of 2 and adds them to the target audience. Since this is a new program, there are no users already assigned to the program so all are added to the program users table.

The program launch code then defines the competitions within the program. It identifies the metacontestants as 1) users within stores and 2) stores within divisions. The first metacontestant, users within stores recurs monthly, so the code adds the end date to (today+1 month) and creates a ‘container’ for each store within the west division, creates the store competition and within each store ‘container’ it adds all users belonging to that store within the target audience. Each of these users are then added to the store competition. Once this is completed the program loops through and does the same thing for the subsequent metacontestant, stores within divisions. This metacontestant competes on a quarterly basis, so the code adds the end date of (today+3 months), creates a ‘container’ for the west division, creates the west competition, adds all stores belonging to the west division within the target audience, and finally each of these stores are added to the west competition.

### Questions

Once a program has been launched, the program will also generally require associated questions, as discussed with respect to FIG. 11.

Questions can be added from scratch or copied. For reporting and record keeping (audit) purposes, it is preferred that questions be maintained and that controls be placed on how they are edited.

Questions may be configured in many formats, for example, multiple choice questions. In this case, the correct answer is specified as one of the options or can be included in a drop-down list or the like. Questions may also be matching questions or drag and drop questions/answer or questions relating to a scenario. The questions should have a correct answer if being associated with a quiz (as opposed to a survey, which may have free-form answers). Questions are typically grouped by subject matter.

Open ended questions may allow for a free-text entry. An open ended question may be credited as one or both of 1) question answered and 2) question correctly answered.

Questions may be configured to link with programs in various ways, such as:

questions may be associated to a specific program during question or program generation; or

questions may be categorized according to the same categories that are used to configure programs and have the question picker (as described below) associate questions with programs having the same categories.

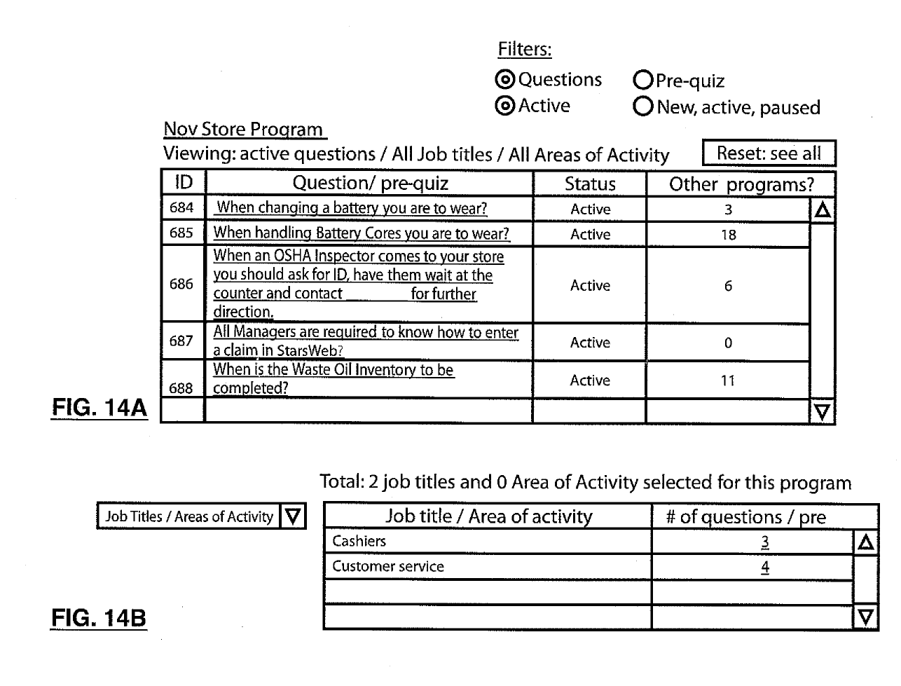

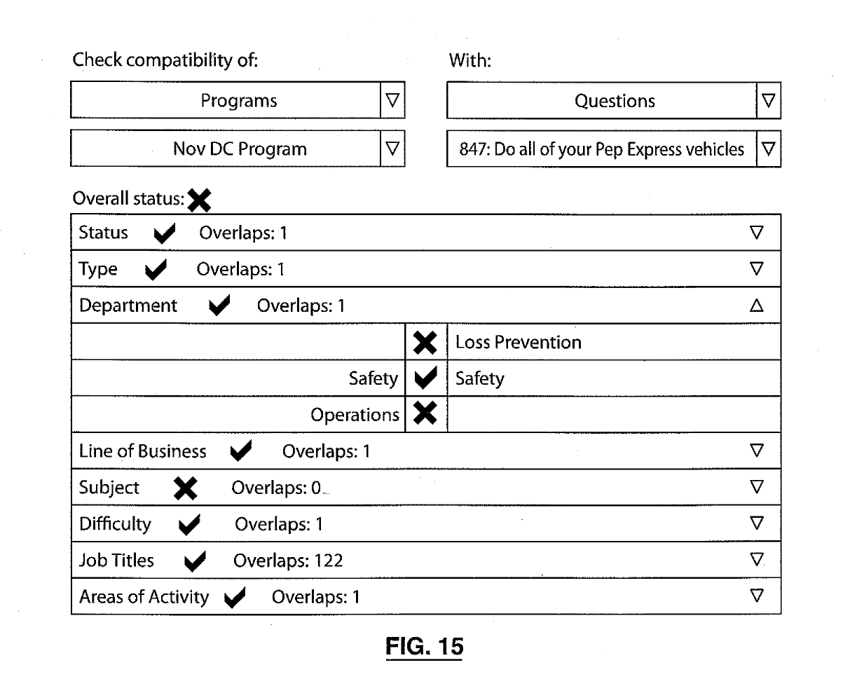

The commonality of categories between programs and questions may determine the pool of questions asked in each program. Once questions and programs have been added into the system, a compatibility check may be performed, for example to view the questions that meet the parameters set for the program. An example of a compatibility check screen is shown in FIGS. 14A, 14B and 15.

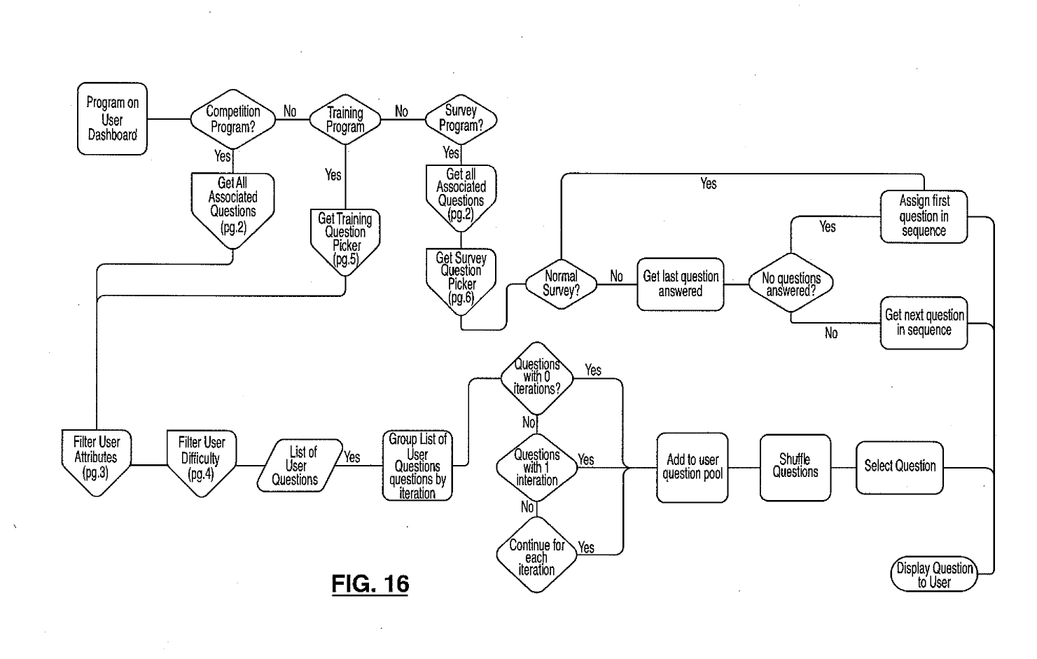

FIGS. 16 to 20 illustrate, in flow chart form an example question picker module and its interaction with the other modules within the training system. A user will start by logging into 800 the dashboard or home screen of the training system. The training system will then display the various program instantiations that are available to the user. The program instantiations may be for example a quiz 810, a pre-quiz activity such as a training program 820, for example an internally or an externally supplied program, or a survey program 830. As noted herein, the user may be directed by the dashboard to select a particular activity first or select activities in a predetermined order.

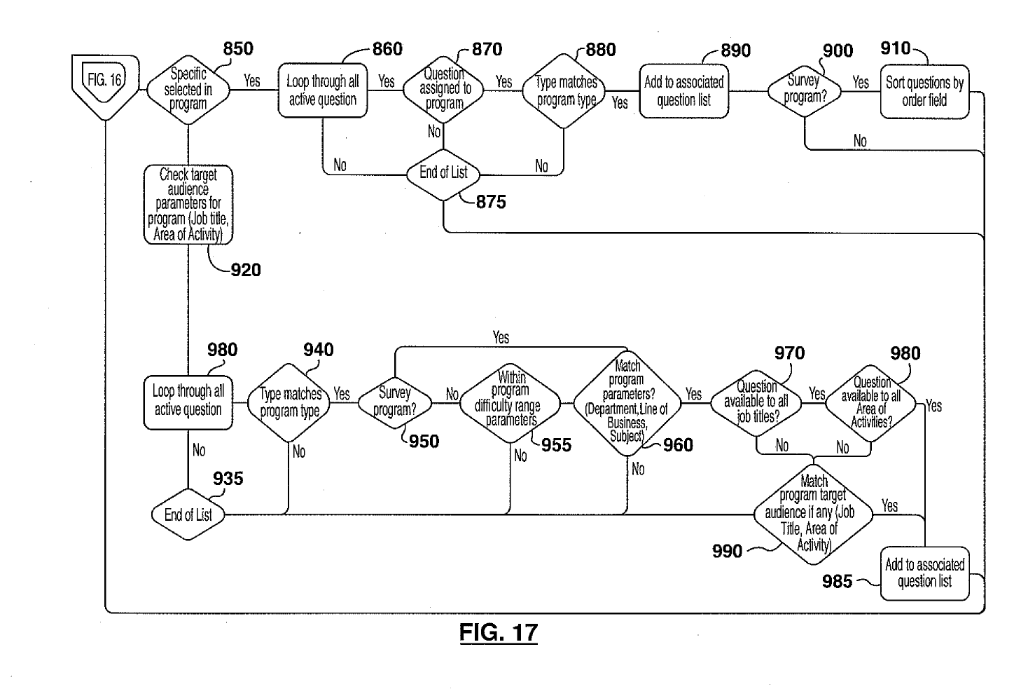

If the user selects a quiz 810, the question picker will then review the questions and retrieve the questions 840 associated with the user's quiz program. FIG. 17 illustrates, in flow chart form, how the question picker retrieves and returns questions associated with the user's quiz program.

The question picker will first determine whether the program has questions that have been specifically associated 850 with the program or whether the program instantiation is open ended and the question picker needs to associate questions with the program.

If the program instantiation has specific associated questions, the question picker will loop through 860 all the active questions and determine what questions have been associated 870. If no questions match the program type or if there are no active questions in the question database, the question picker will return no results 875. Once the question picker matches questions with the program type 880, the question picker will ensure that questions have been associated and will add these questions to the associated question list 890. If the program is a survey program 900 the question picker will then order the questions 910 prior to sending the question list to the program instantiation.

If the program instantiation has been selected to be open ended when associating questions, the question picker will check further parameters associated with the program instantiation 920 such as job title or area of activity. When these parameters are retrieved, the question picker will loop through the active questions 930, if no questions match, the question picker will determine that there are no active questions for the program 935. If questions are found matching the program parameters, the question picker will determine if it matches the program type 940. If the program is a survey program 950 the questions are compared to the remaining program parameters 960, if not a survey program, the difficulty range of the questions is determined 955 and only questions within the appropriate range are selected to be added to the question list 935.

The remaining parameters are matched within the question parameters and then the target audience is determined. The questions that match all job titles 970 and match all areas of activities 980 will be included in the question list 985. Questions that have specific target audiences will be matched 990 with the parameters of the parameters of the program instantiation and these questions will be returned to use in the program instantiation.

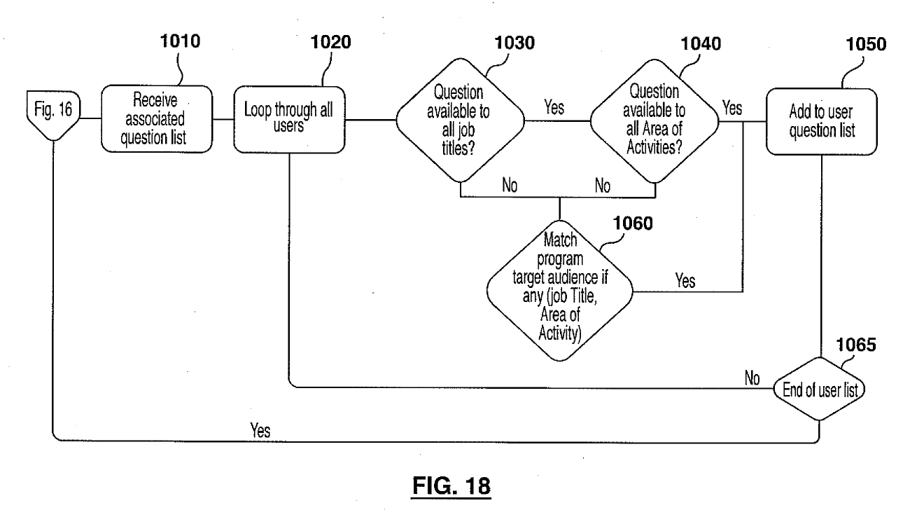

Returning to FIG. 16, now that the question list has been received by the program, the questions will then be filtered based on the user's attributes 1000. FIG. 18 shows the flow chart of matching the user attributes first by receiving the question list 1010. The question picker will loop through each question in the question list 1020 that is associated with the program. The questions that are either categorized as available to all job titles 1030 or all areas of activities 1040 will be added to the user question list 1050. Questions that match the user's attributes 1060 will also be added to the question list 1050. The questions that are not part of the list will be filtered out of the associated question list. This filtered list will be returned 1065 to the program instantiation.

The questions can be similarly filtered through various other filters based on parameters. For example, based on difficulty range 1070.

Once this list is returned 2060 the questions are grouped by, for example, iteration 2070. In this situation, questions that have 0 iterations 2080 may be asked ahead of questions with at least one iteration 2090 The questions can be shuffled 3010 to produce a random order and a question is selected 3020 to display to the user 3030.

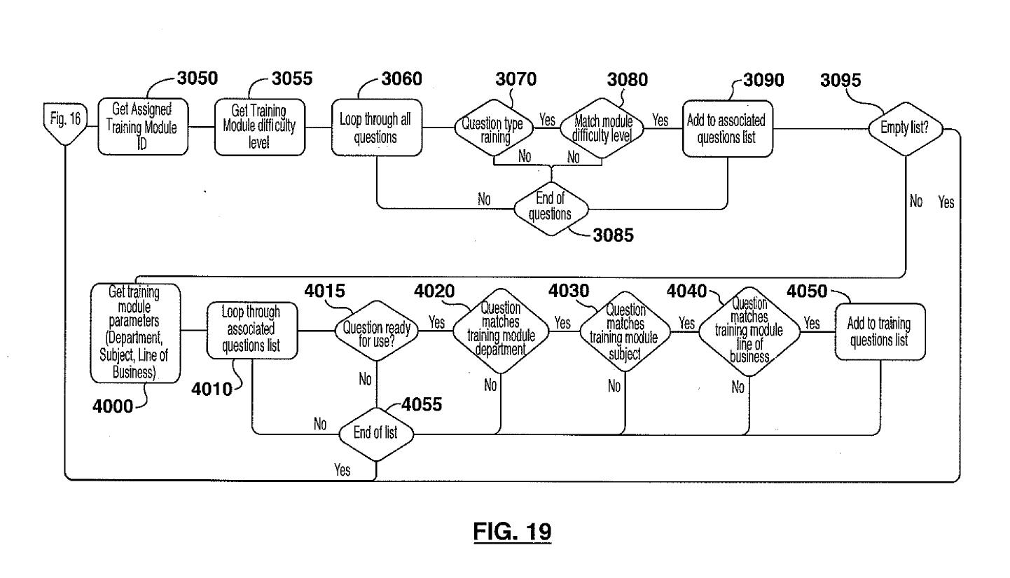

Returning again to FIG. 16, if the user selects a training program 820, many of the steps are similar, although the selection of questions 3040 by the question picker may vary slightly. When the user selects a training program 820, the question picker will begin by creating a list of questions matching the training program instantiation parameters. As shown in FIG. 19, first the question picker must determine the training module's ID 3050 and the training module's difficulty 3055. The question picker will loop through 3060 the questions and find questions that match the program type 3070 and the difficulty level 3080 until no questions remain 3085. If no questions match the question picker will return no questions 3095. Questions that match these parameters will be associated with the training program instantiation 3090.

Once the base list has been created 3095, other training parameters may be determined 4000, for example, the department, subject, or line of business. The question picker will loop through 4010 the associated question list and determine if the questions are ready to use 4015, if the question matches the training module department 4020, subject 4030 and line of business 4040. If the question matches all the training program parameters the question will be added 4050 to the associated question list and then the list will be returned 4055 to the flow in FIG. 16.

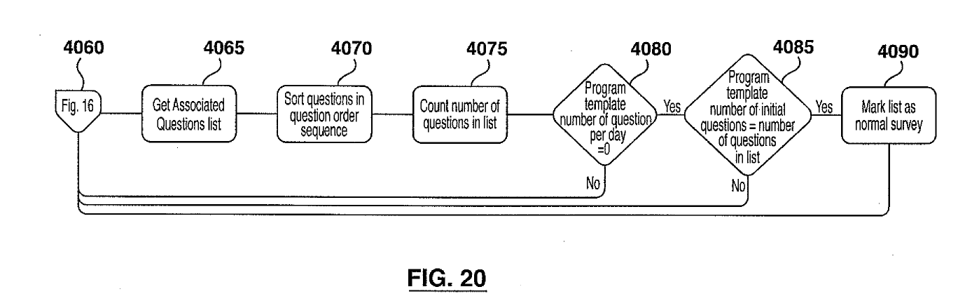

Returning to FIG. 16, if the user selects a survey program 830, the flow chart outlining determining the associated question list 840 follows the same routine as in a quiz program, except with the added step that the question list will be ordered as per the survey program's ordering. Once the list is determined the list will be sent to the survey program instantiation. The associated questions will then be sent to a survey question picker, as shown in FIG. 20.

The survey question picker retrieves 4060 the associated question list 4065 and sorts questions in order of sequences 4070 then counts the number of questions in the list 4075. The survey program instantiation may be set with a specified number of questions per day. If it has been set for zero 4080 and the number of initial questions in the program equals the number of questions in the list 4085, the survey is identified as normal 4090. This identification is sent to the survey program instantiation and from there the survey questions may be asked to the user 5000. If the survey is identified as not normal, the question picker will determine the last question answered 5010. If no questions are answered 5020 the first question will be asked 5030, otherwise the next in sequence will be asked 5035. These questions will be displayed 3030 to the user.

Survey or audit questions are a type of question that can be asked within the post-quiz program or other quiz program to map which are the areas (categories) each associate demonstrates consistent knowledge, the ones where he or she rarely exhibits knowledge and any level in-between. The goal is to allow the training system to adapt to each employee/associate and provide appropriate training. For example, the training system may use a priority parameter to assign a higher priority than others, so that the question picker takes the training program priority into account in its distribution of questions.

Another parameter used in auditing is a success score, which may be a percentage that is calculated by the system. The score indicates whether an associate consistently demonstrates knowledge about a group of categories. This number may preferably only be calculated after a statistically significant sample of answers has been gathered but the system does not necessarily need to be limited in this way.

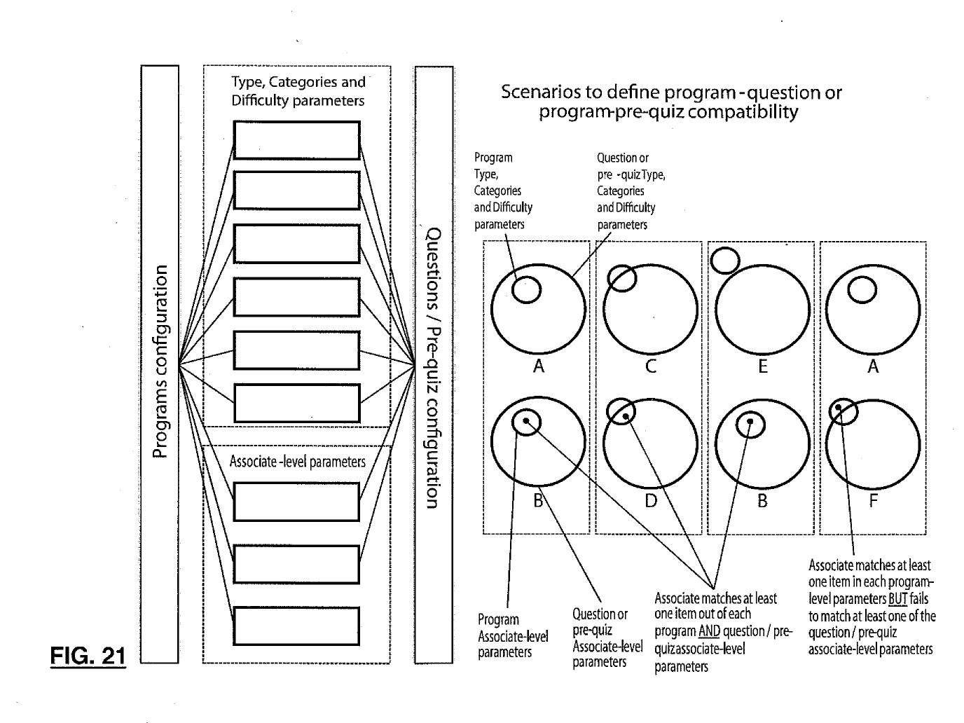

Various scenarios illustrating the intended adaptive nature of question picking are shown in FIGS. 21 to 23.

A threshold may be one of the variables stored within the training system. The threshold may be a percentage or a range or a fixed number. The threshold could be changed depending on results from associates or may be a different threshold depending on the subject of the program or the area the program occurs. If the threshold of the associate's overall knowledge is below what several training programs require, the system may assign an appropriate program or raise the priority of a particular program.

Consider an associate who has received an 80% score on Fire Safety; 50% on Personal Protective Equipment (PPE) 30% only on batteries. The associate will not be entered in Fire Safety training, as he has received a higher score than a predetermined threshold of 60%. He will, however, be trained in PPE and Batteries. In the system, PPE training has a higher priority than battery training. As a result, the associate will be trained on PPE first, and batteries second, even though he has a lower knowledge on the latter.

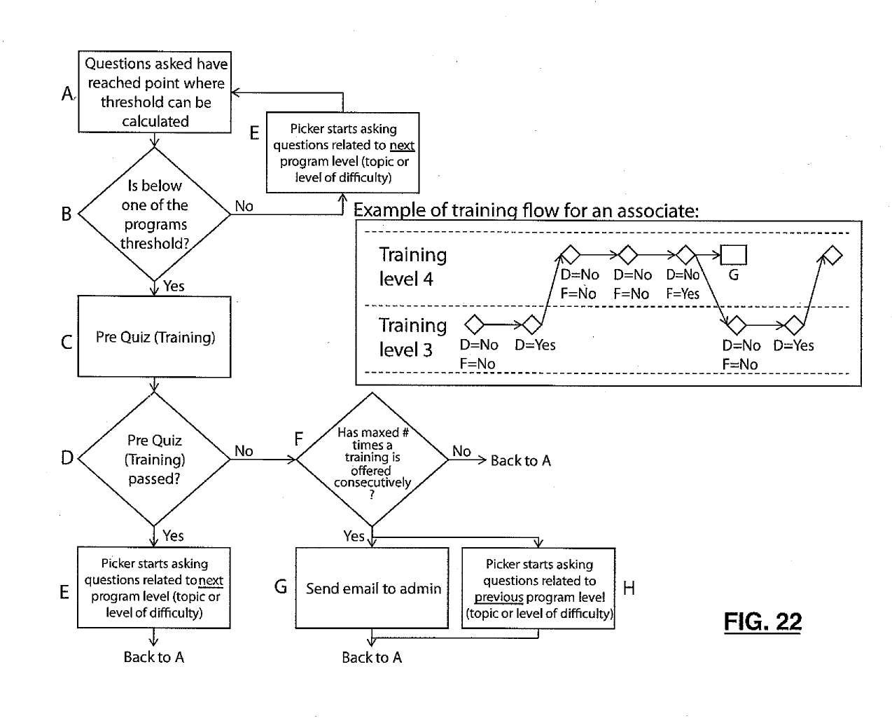

As shown in FIGS. 21 and 22, if an associate passes the threshold successfully, the question picker in all programs, including quiz programs, should start to exclude questions at the initial level and up the difficulty by a level. If the system runs out of difficulty levels for this associate, the system may stop asking questions about this program or topic or schedule some refresher questions at an appropriate time-frame in the future, for example a quarterly or annual review.

If the associate passes the training (FIG. 22, D=Yes), the question picker may then start submitting questions of a higher difficulty to the associate. If the associate did NOT pass the training, the question picker would check if that associate had already taken this or a similar training in the recent past. If yes, the question picker would count how many and, if a predetermined number of trainings have been taken without success, an email may be sent to the administrator(s) listed in the program configuration. The question picker could also be relaxed a little, in order to submit easer questions (in a particular domain) to the associate.

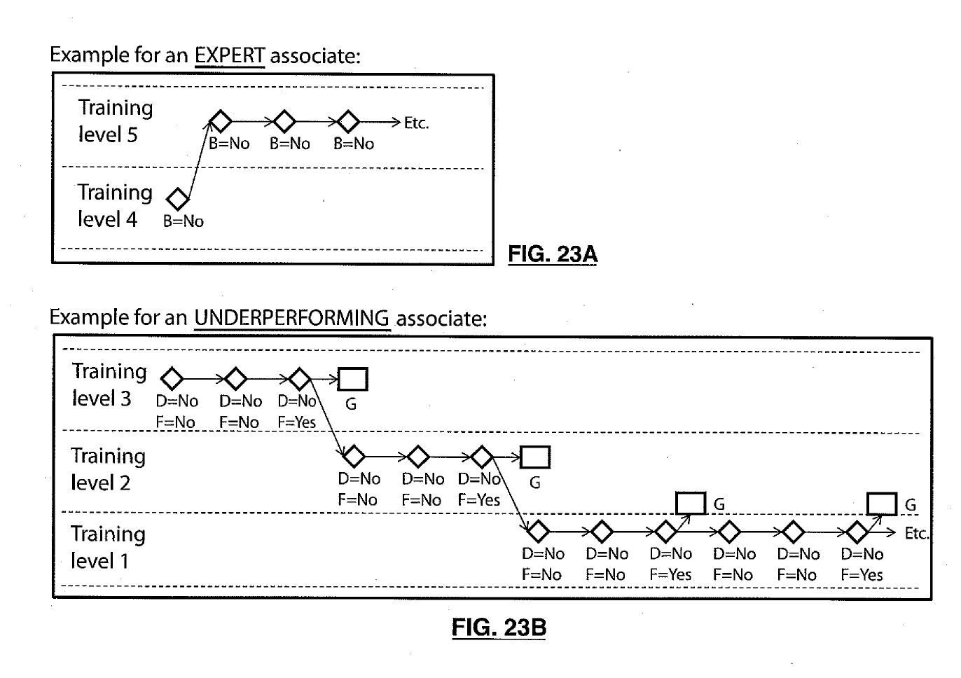

As shown in FIG. 23, a user may move up or down in a difficulty hierarchy based on results. As shown in FIG. 23B, an underperforming associated may reach the lowest level of difficulty, the system will keep on asking questions until there is a manual intervention or until the associate finally learns and passes to the next level. In another example, the associate may reach the highest difficulty level as in FIG. 23A and will be asked questions with the high level of difficulty until underperforming in an area and being moved down a level, as shown in the training flow described in FIG. 22.

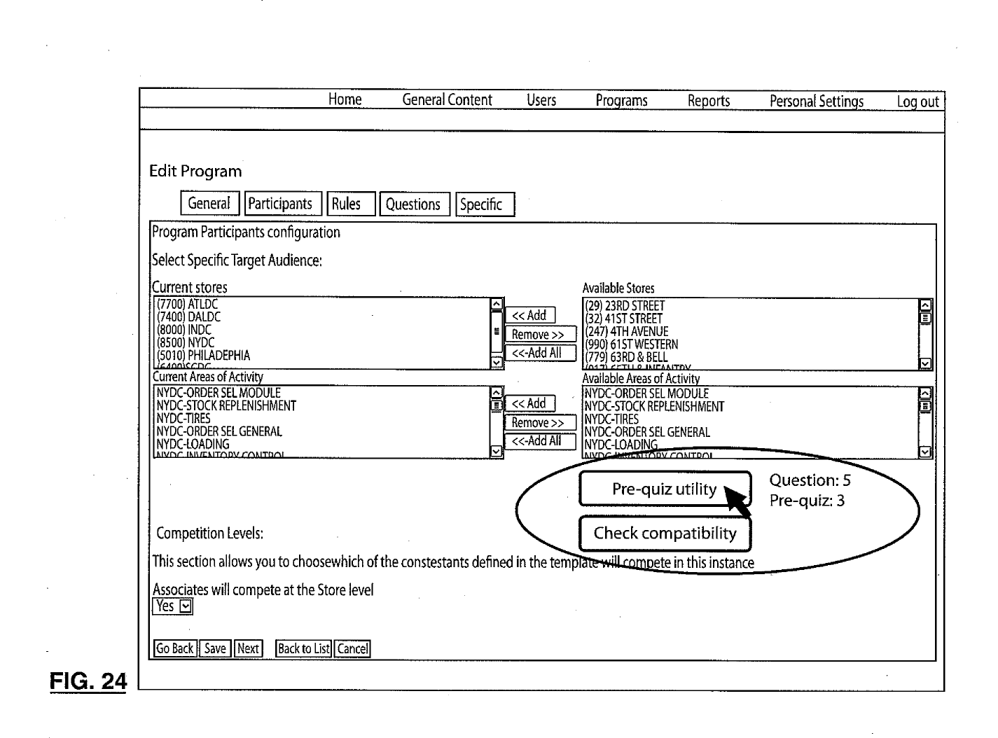

The intent of the compatibility utility is to be able to measure results and adapt the questions based on those results and on historical data with the goal of making the questions relevant and more engaging. The compatibility utility may include high level statistics, which allow the administrator to see at a glance how many links were established by the pickers with pre-quiz and questions. A “Check compatibility” button, as shown in FIG. 24, may be included and leads to the compatibility utility. The intent of the compatibility utility is to understand, through a compatibility check, where any disconnects between questions and programs may be located.

The compatibility utility may, in some cases, be more granular than the pre-quiz utility. For example, the administrator may be able to pick one item, for example, a specific pre-quiz, question or program, and map it to a specific other one to see where the connections are established or where any disconnects are happening. It will be understood that many filters may be available to allow selection based on many parameters or aspects.

An impact of pre-quiz development on the way questions are allocated may be an additional category which allows questions to be assigned to a specific pre-quiz. The question picker may have to take a difficulty level into account to link a question to a program or a pre-quiz. Otherwise, the ability to have the same question be asked slightly differently in a training module vs. non-training environment may be provided.

In one example, in a training program, a question can be asked with purely text as the user has just seen the training and has specific situations still in mind. In a quiz program, the exact same question could perhaps be asked with a drawing next to it, to make it more explicit.

In some embodiments, there may be controls to ensure that a limited number of questions are asked/answered in each session, with the goal of keeping the training/quiz in a predetermined time frame to keep the process relatively brief. For example, the system may be configured to keep the number of questions under approximately ten, even if the employee has been away or missed a portion of the program.

The tracking of questions may be done at any of various levels, for example, at an associate level or other entity level. Tracking may include aspects such as:

Historical aspect: keep track of the questions associates have answered in the past 6 months, and how many times the associates have answered the questions as a question can be set to be asked more than once.

It is preferred that a question will be asked again (if configured to be asked more than once) only once the entire associate's pool of questions has been exhausted. If the pool runs dry of questions to be asked, the system may just pick a random question, which follows the logic of the categories association.

Questions may be importable in batches through, for example, a CSV file import or through another form. In one example, the system may provide an Excel template that is downloadable on the Quiz module page.

Tracking may be included in various modules of the training system. For example, timers may be used to track timely performance on questions, total time on the system or various other parameters. Other elements of tracking may include participation, percentage correct, difficulty levels and any other appropriate parameters.

Category management allows a company to define the structure of the company and the categories/subjects to ensure that reports are meaningful. The category management component of the system is used to allow an association to be made between different elements in the system such as programs and questions. Company structure may include departments, lines of business (LOB), job titles and/or areas of activity. These can be configured on the admin consul but can be used in program, pre-quiz and question configuration.

The category/subject structure of categories may be a hierarchy-list structure that may allow for nesting. The field may appear in a hierarchy concatenated in the lists.

### Pre-Quiz

There may be various pre-quiz types, for example, survey pre-quiz, training pre-quiz, etc. Training modules may be one pre-quiz type. Training modules are intended to contain the actual content and layout of each training. They may be independent from the training templates or instantiations as there might be more than one training module per instantiation and, vice-versa, a same module could be assigned to different training instantiations.

In an example, several different “fire safety” modules, each presenting the same information but in a slightly different way, may be part of the Fire Safety training instantiation. They can be presented in random or prioritized fashion to the users who are submitted to that training.

In one case, the system may keep track of the fact that this training was already offered to an individual as part of another program instantiation, much in the way tracking works for question, and it would not be offered again to the individual unless there were no other choices of trainings available.

As described above, predetermined trainings may be described as a type of “pre-quiz”, however, in reality, a training program may consist of both an input (pre-quiz) and specific questions or a quizas well as potentially a scorecard (or other post-quiz) at the end. In this way, a training may include interaction between the program management component and the question component, similar to that described above for question/quiz programs.

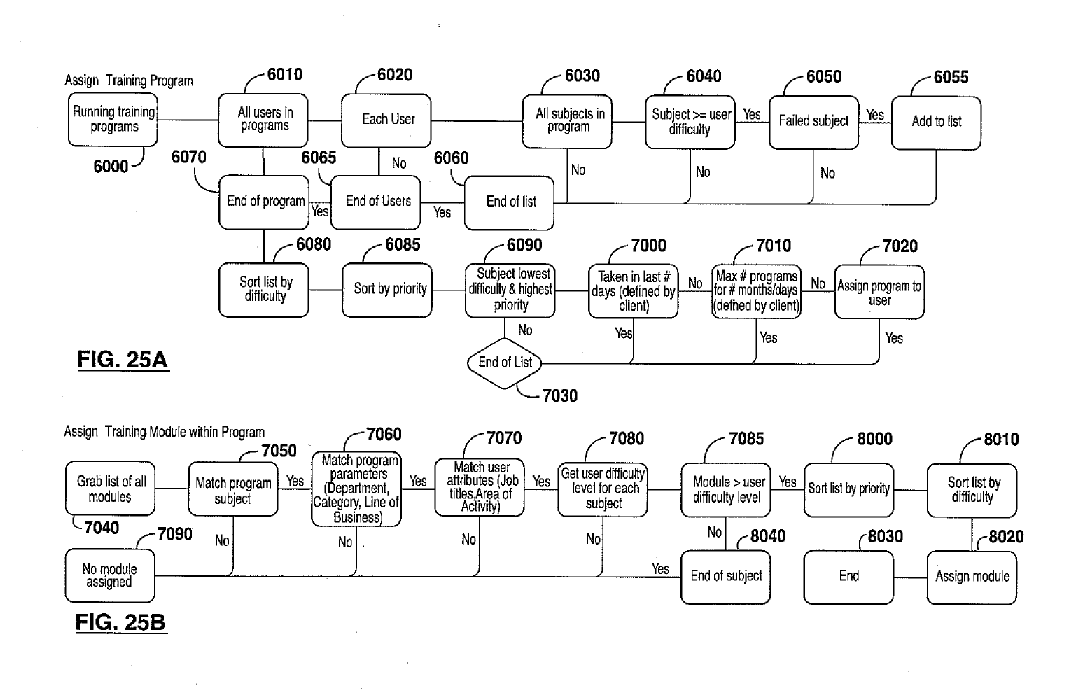

In any event, there will be situations where some form of training will need to be linked with a program, whether as a pre-quiz or as the whole program. The training or pre-quiz linker provides this functionality and allows the system to assign training programs or other pre-quiz programs such as surveys or announcements to a user. The intent of the training linker is to assign the proper pre-quiz activities to a user, be it a survey as to why the user was not successful in an activity or training modules with a specific program instantiation. FIGS. 25A and 25B show flow-charts for the training linker in two situations. In FIG. 25A the flow of the pre-quiz linker when assigning training programs is shown. The pre-quiz linker has access to all active training programs 6000 and all users 6010. The pre-quiz linker will then match available users of the system to the training programs by reviewing each user 6020. At first, the training subjects are determined 6030. If the subject is within the range of the user's difficulty level 6040, i.e. if the difficulty of the training program is equal or greater than the user's current difficulty level, the training program instantiation will be assigned 6055 to the user with the same categories and parameters. If the user has failed 6050 a certain subject or training, the training may be visible even though the user has previously completed the training. Trainings that are below a user's difficulty level will not be shown to the user unless they are a mandatory training program or unless the user begins to fail questions on the subject and the user's difficulty level drops. The pre-quiz linker will complete a list 6060 for each user and users for each program 6065 until all programs have been reviewed 6070. The pre-quiz linker may be constantly comparing the available programs with the user's parameters or may run at predetermined intervals to update the programs available.

Once the list has been created the list may be sorted by difficulty level 6080 and or by priority of the training program 6085. The users, when logging in, will be shown the list of programs available for that specific user based on his or her own area and difficulty ratings.

The list may be further modified through other parameters of the training system such as difficulty level and priority level 6090 whether the training program was taken within a certain period of time 7000, a maximum number of training programs per day, week, month, etc., 7010 or specifically assigned training programs 7020. The list of training programs 7030 will then be displayed to the user.

Contrary to quiz or survey programs, training programs may not have a winner's dimension. The philosophy of training programs may be quite opposite: where those other programs constitute a carrot for the users (possibility to win points for an overarching goal of winning a competition, or being punished for not following the rules: penalties with the risk of losing one's advance or even cancelling a game), training programs can be mandatory and can even block other programs. The main difference is that training programs will have a “participation rate” associated with completed modules/pre-quiz rather than questions.

FIG. 25B shows assigning training modules within a program to a specific user. The pre-quiz linker will first gather all modules 7040 and match the program by subject 7050 then match the various program parameters 7060 such as department or category of the program. Next the user's attributes are found 7070 and compared with the training module and the user's difficulty level in each of the training subjects 7080 is found. The user will be assigned modules that have a higher difficulty rating that the user's current rating 7085. If no training module meets these criteria, none will be assigned 7090. If at least one training program matches a user's parameters and difficulty level the list will be sorted first by priority 8000 than by difficulty 8010 then assigned to that user 8020 until all modules have been reviewed 8030 or no modules meet the subject criteria 8040 It will be understood that a survey or announcement may be assigned to users of the system in the same manner as a training program. For example, an announcement congratulating a user meeting a specific difficulty level may be displayed to a user based on the user parameters linked to the user by the pre-quiz linker.

It will be understood that the system may include various utilities that allow an administrator or other person to develop web pages for the various elements of the programs. Alternatively, the system may link to external resources for developing web pages or the like for presentation to users.

### Post-Quiz

One component of the training system may be a gaming module, which may typically be included in a post-quiz component. In one example, a Safety Bingo Game is provided and may aid in the sphere of knowledge probing and e-learning, other post-quiz could be launched on a regular basis. Further post-quiz or programs may allow for more diversity and narrow down programs to be fully adapted to different groups of people in the organization.

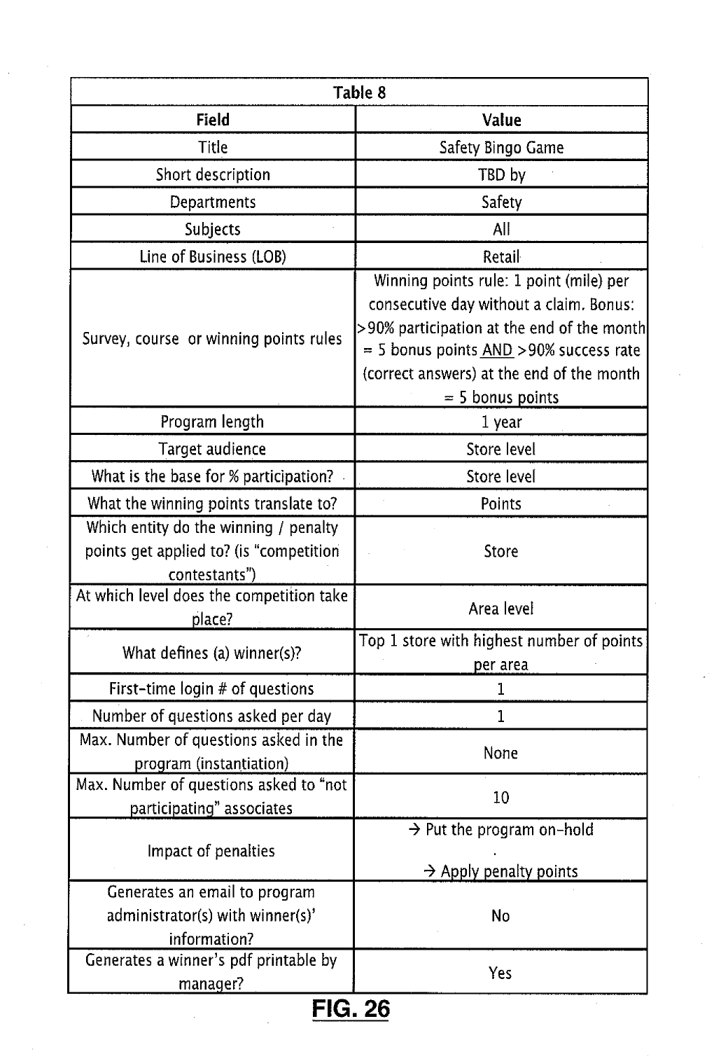

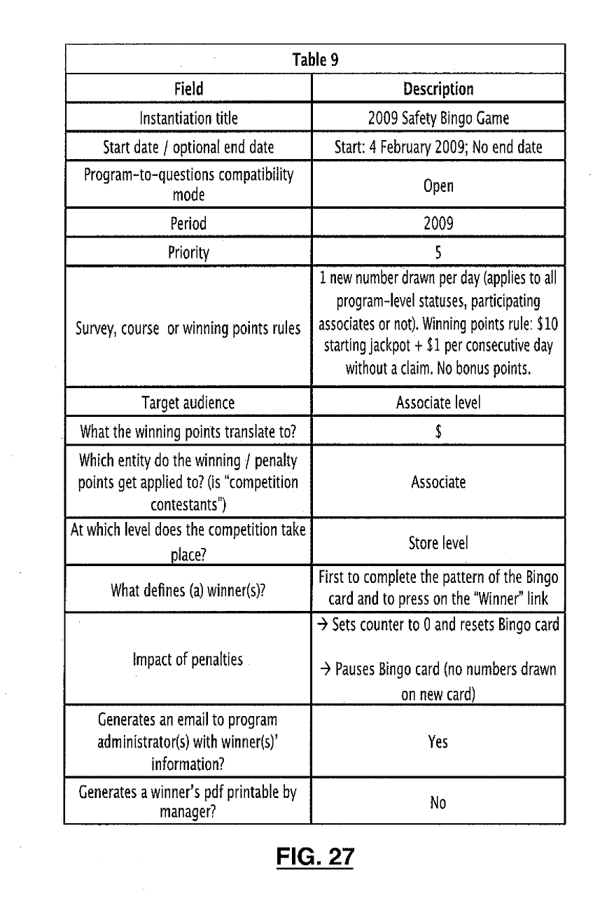

Similar to other elements herein, the post-quiz elements may include both templates and iterations. For example, FIGS. 26 and 27 show example fields for a template and instantiation of a Bingo game.

It will be understood that various types of games may be included in the post-quiz module in order to encourage participation. Games of chance that provide prizes (money or otherwise) have proven to be successful at keeping attention so these may be particularly effective in generating interest.

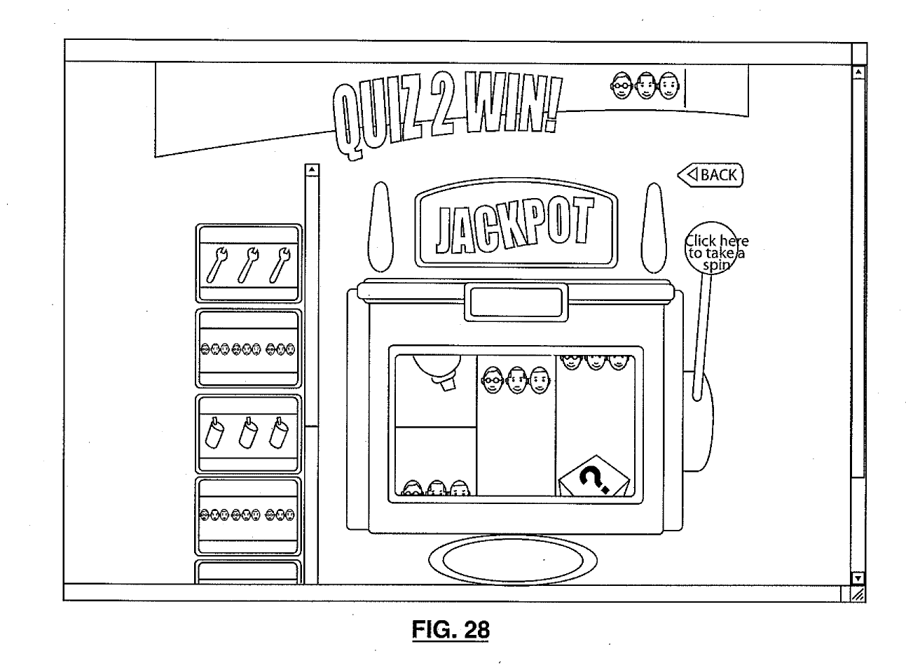

Another example of a game for the gaming module may be a one-arm bandit game as shown in FIG. 28. In one example of a one-arm bandit game, the number of plays or pulls an associate may receive on the game may be directly tied to the number of questions the associate has answered. For example, if the associated has answered three questions, he or she may receive three credits that result in three plays of the game. The points may be awarded only for questions answered correctly, or may be awarded for each question attempted or for some other combination of parameters.

Most games of chance pay out with prizes or the like based on probabilities and may involve random number generators. However, in the training system herein, as the games are being used to drive behavior, the system administrator can be provided with more detailed control over the provision of prizes based on various parameters, including individual, store, department or other performance or behaviour.

For example, the prizes may be assigned in various categories, with some of the higher valued prizes only being unlocked if the store, or host of the training system, entity or user has reached a certain threshold, for example a minimum number of consecutive accident-free days. A list of previous winners and the prizes received by the winners may also be viewable by the associate when in the gaming module.

In one embodiment, the training system may divide or allocate various prizes or winning items to the various stores or hosts of the training system. As the value of the prizes varies, the quantity of each prize type will typically vary as well. Some prizes, for example prizes of a larger value may be distributed on an organization level while other prizes will be allocated to each user or store or the like, for example participating in the program associated with the post-quiz.

When an associate wins, for example when a pull reveals three identical items on the one arm bandit, a message may be displayed stating that the associate is a winner and may also display the prize information, the steps or actions required to retrieve the prize and may further include a confirmation number that can be compared against information stored in the training system. The confirmation number is intended to verify the winner.

When the training system determines a winner the system will alert, for example via email or online message, those responsible for the prize pool that a prize has been won and the information of the associate who has won the prize. This message may be directed to the store manager, an administrator or a specific person in head office.

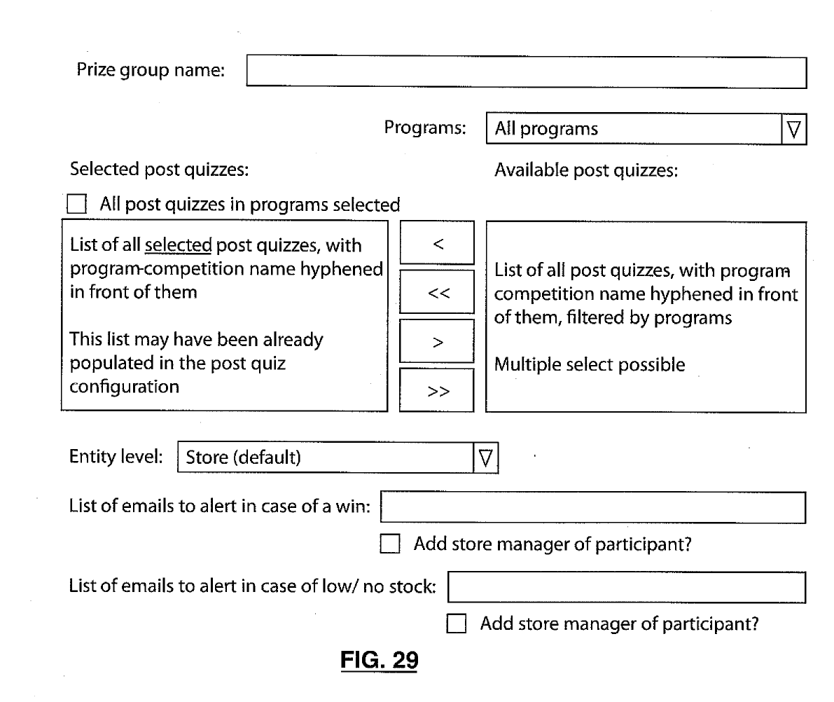

The administrator has the ability to setup a number of prizes for various parameters, for example, all entities (same set) and per competition. Various competitions may have separate and distinct prizes associated with them. Under the program menu, as shown in FIG. 29 and as described above, the administrator may select the “prizes” option. Once in the prize module, the system may display a list of the prize groups and the correlation between the program or competition and the prize group. The administrator may also be shown the type and quantity of the prizes in each group.

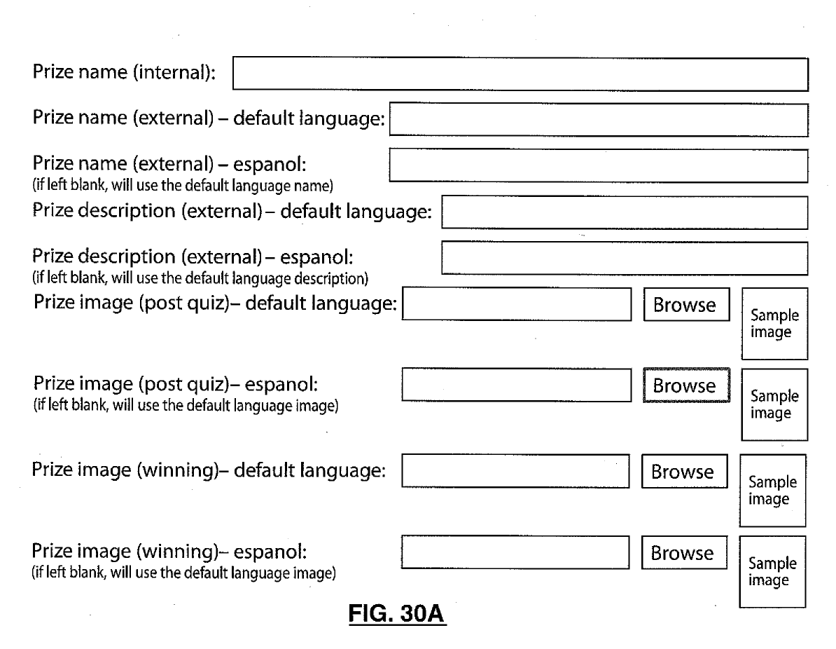

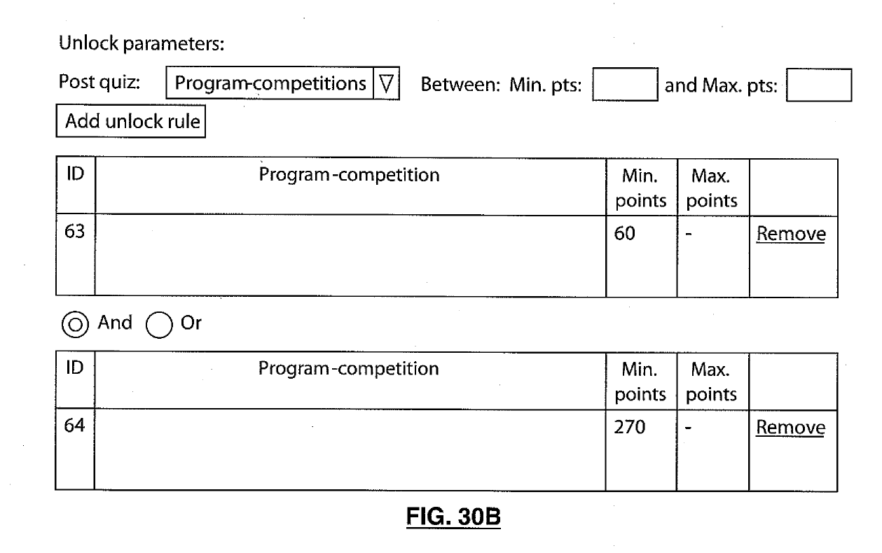

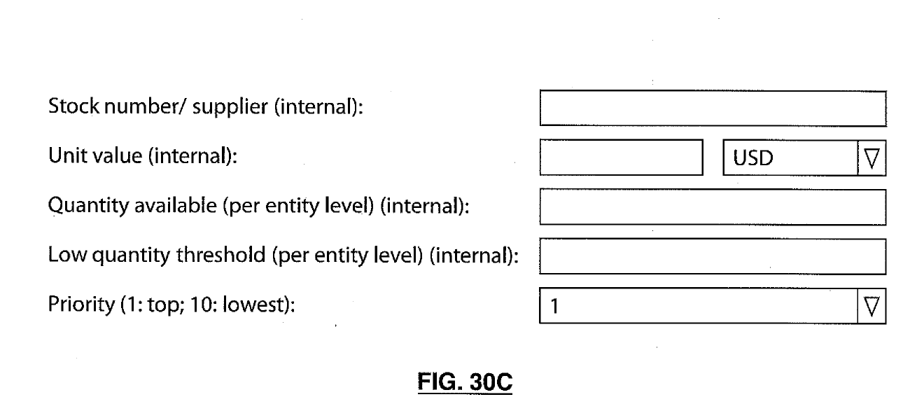

An example of prize-related fields is shown in FIG. 30A to 30C. Images of the prizes may also be displayed as well as other parameters such as the correlation with the programs or competitions and who should be notified if a prize within that category is won, or is running low on stock.

The inclusion of the gaming module is intended to link participation of the training system with rewards to encourage associates to login on a regular basis. The gaming module and the prizes may be tailored to the host or organization running the training system. The winners may be picked randomly or strategically, for example a threshold range of days may be set for when the gaming module awards a prize, and a maximum number of prizes to be distributed may also be set. The ability to deliver these prizes strategically is intended to ensure that the prize budget may be set and not exceeded but an associate may still have a relatively random chance at winning. Prizes may also be prioritized in order to distribute certain prize categories at certain times. For example, an administrator may want to distribute a coveted prize at the first month of a program to increase the associate's desire to participate in the program, or there may be some delay created to increase suspense over the proposed prizes.

In one example, illustrating a possible many-to-many relationship, one program may result in multiple competitions, wherein an associate may accumulate 1 point per every question answered in the program and the overall store may accumulate 100 points per consecutive accident free day. These points may be considered the same type of points or may be considered various levels of points. As they may be differentiated on who accumulated the points, for example, associate points or store points.

In one example, a predetermined threshold of points is required to unlock higher value prizes. These predetermined thresholds may be a combination of various categories of points or may be only a single category of points. In one example, points may be accumulated month over month, while in another example they may be reset every quarter or reset every month.

Many of the parameters from the program module may be imported and used in the gaming and competition modules.

Other attributes of the gaming modules may include the module having a post-quiz where if points are accrued they may be used to unlock specific prizes in a post-quiz module.

Point accumulation rules for the gaming module may vary per game or per competition. There are various ways points may be accumulated and compounded, for example, a store may get 1,000 points for reaching 60% participation, add another 1,000 if they reach 80%, etc.

Points for participation and success rates may be calculated on a monthly basis or daily basis or on another predetermined time basis.

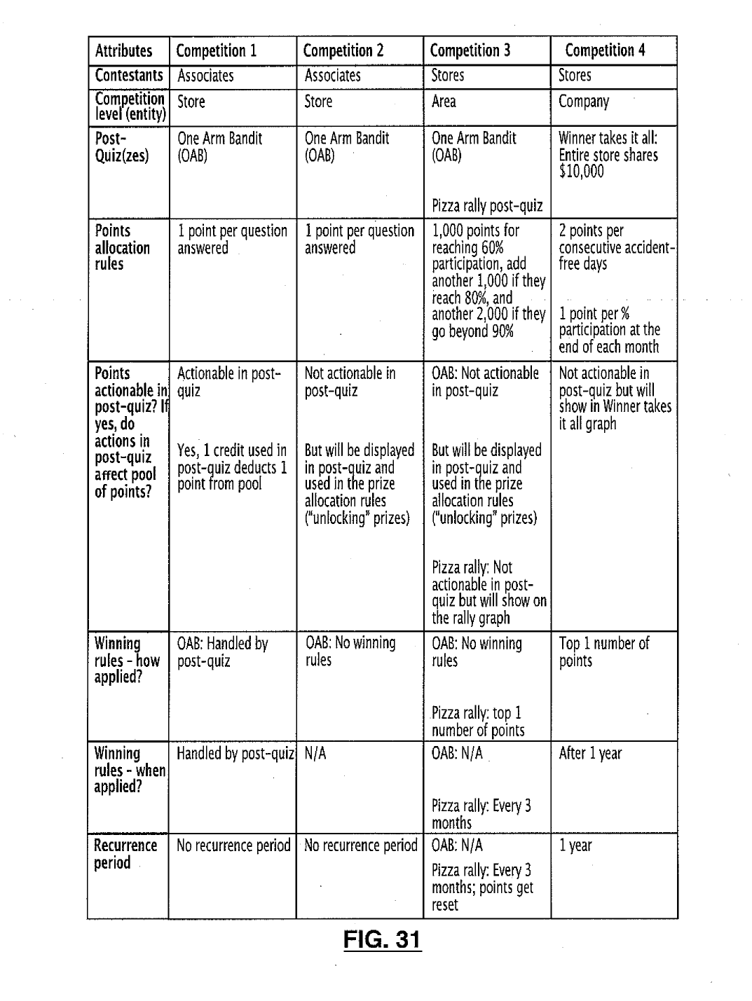

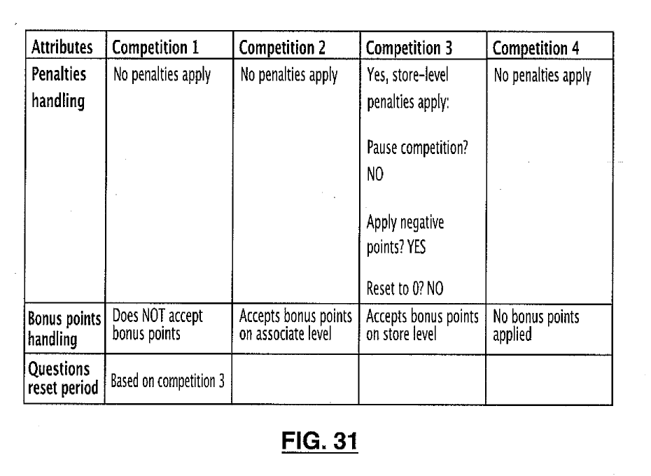

The gaming module may have specific winning rules attached to each game or competition. These rules may determine how and when a win is calculated. The winning rules may also be nested, or may be able to determine quarterly or yearly winners. An additional option consists in transferring the winning rules to the post-quiz which will then handle the win calculation. Each game or competition may have specific rules on the handling of penalties: whether penalties can apply negative (penalty) points, reset points to 0, and/or pause the competition or the like. The gaming module may also have specific bonus point rules on how bonus point may be added to a specific competition. Examples of various competition levels and rules that may be associated with a competition are shown in FIG. 31.

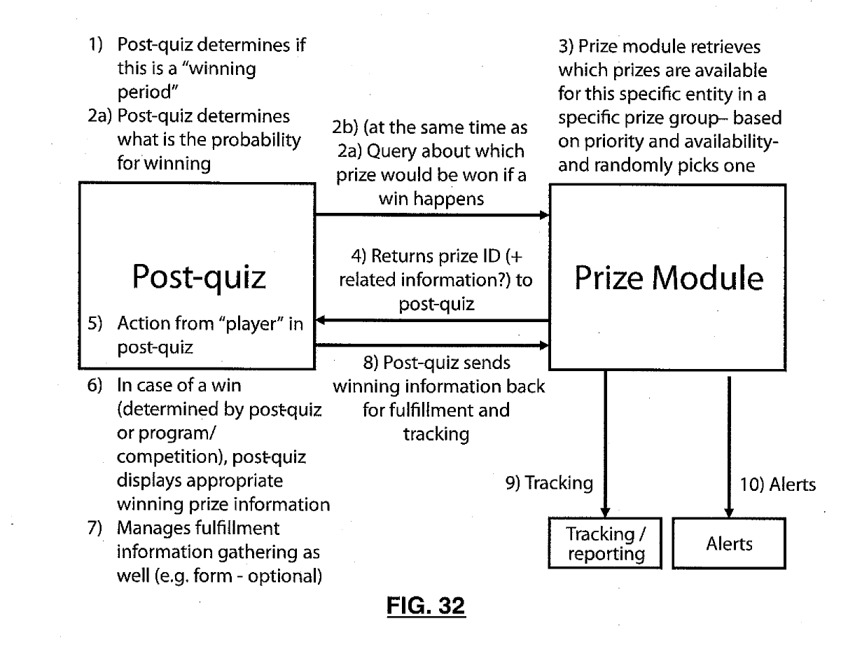

The work flow shown in FIG. 32 outlines various example interactions between the post-quiz (gaming) module and the prize module. For example, the prize module may consider the availability of prizes, one-by-one, so that items with the highest quantity remaining will stand a greater chance of being picked. The prizes may then be retrieved across different entity levels.

An example of a specific game, the one-arm bandit (OAB), is described below. A static image is displayed prior or just after pulling the lever and a dynamic image is displayed when pulling the lever or seeing the three items in the wheel animated. In case of a win, display a winning message (potentially with picture)+optionally display a fulfillment step.

A catalogue of available prizes may also be viewable by an associate. The prize list may show “unlocked” prizes first, in decreasing order of value; and then “locked” prizes in decreasing order of value as well. Other arrangements of the prizes are also considered.

It is intended that there be some built in logic and controls in the gaming module that determine the payout of prizes and the like. This logic may remain the same for various embodiments of the training system, while the parameters of the game may change, for example, the game may be a one-arm bandit or various other games of chance but the prize payout back-end may remain the same. For example, in the one-arm bandit game, the logic may affect at least three areas, including: Number of pulls of lever; Level of control of the winning probability; and Actions in case of a win.

The choice of the winning prize may be selected either randomly or strategically by the prize module.

In the example of number of pulls of lever, the one-arm bandit game may offer a number of pulls (credits) assigned to it by the points coming from the program-competitions. These points may be considered actionable points. Further, different points on different entity levels (for example, associates and stores) may relate to different points or only one set of entity points may be actionable. For example, if multiple points are accumulated between an associate and a store, the associate may receive one point per question answered and the pool may decrease by one each time the associate pulls the lever in the game. The store may accumulate multiple points for accident-free days. These points may be used to unlock prizes of a higher value, but would not be actionable points as they do not influence the number of plays available in the gaming module.

The level of control of the winning probability may also be controlled by an administrator or other designated user. For operational reasons, companies may need to have an understanding of the prize budget on a monthly, quarterly and/or yearly basis. One concept is to keep a random aspect to the wins, but to massage the results slightly, for example so that they meet some of the following conditions:
Keep up momentum and associate engagement;
Have a rough idea at the beginning of the period of the prize budget, how many prizes will need to be distributed and make sure that they are not won either too quickly or too slowly; and
Probability to win does not penalize smaller entities.

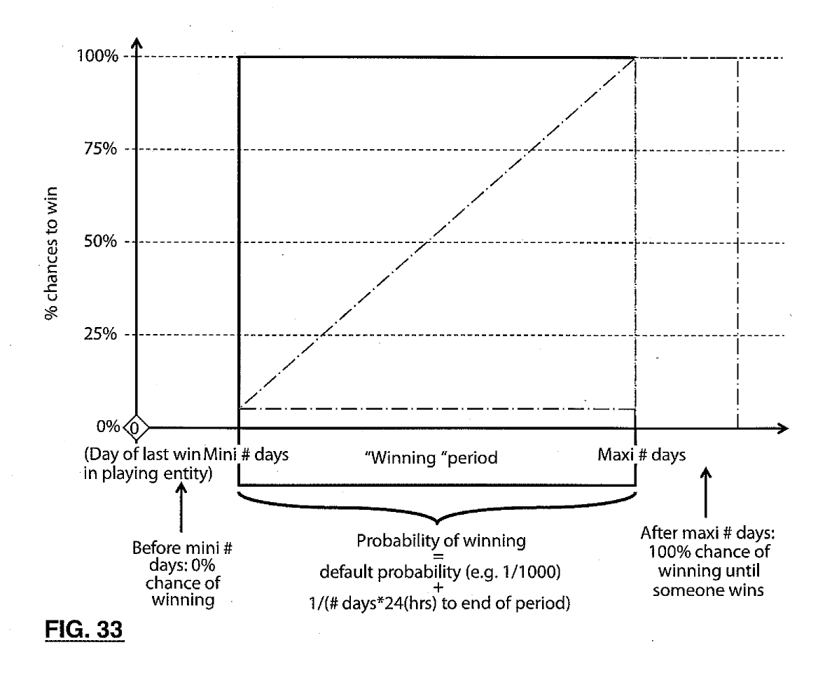

As a part of the control, administrators may set a minimum and maximum number of days or actions (e.g. pulls of the lever) since the last win, between which the system will progressively increase the probability to win. This type of arrangement is illustrated in FIG. 33. At the end of the period, probability may increase to 100%, if there are still prizes to be won. There may also be the possibility to set a minimum and maximum number of wins per moving time window (e.g. max. 4 wins per rolling 30 days).

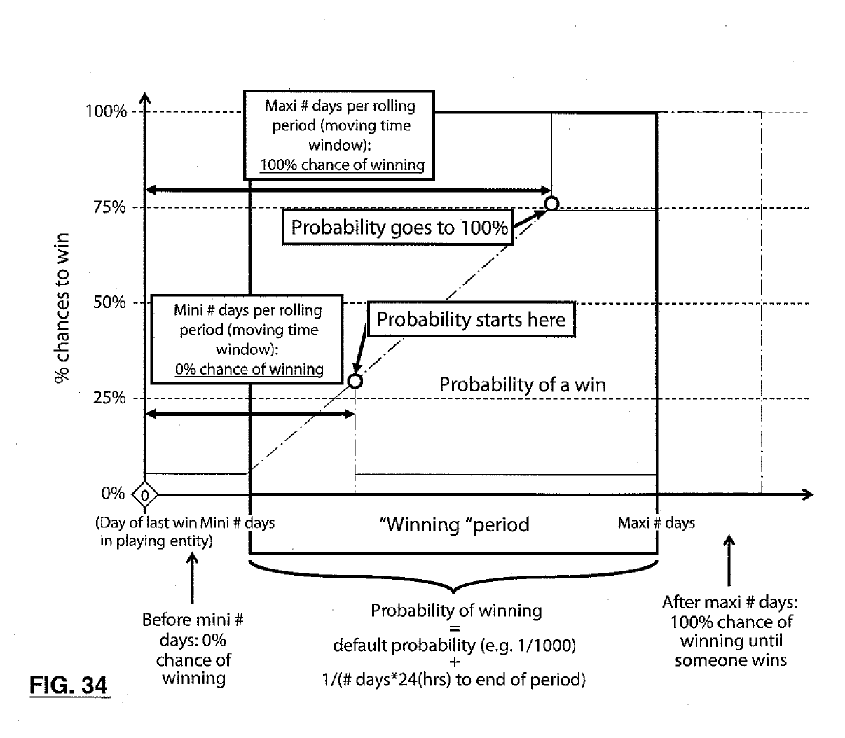

If no min or max are set, the winning chances can be set to be completely random based on the base or initial probability. The calculation of the change in probability may be done on an hourly, minute or second base, which is intended to ensure that one shift of workers does not have a higher winning probability over other shifts. FIG. 34 shows another example of adapting the winning chances as follows:
Before minimum number of days or actions since last win: 0% of winning;
In the winning period (as soon as the minimum number of days or actions since last win has arrived AND if maximum number of prizes per rolling time period has not been reached), apply a formula; and
After the maximum number of days or actions OR if the minimum number of prizes has not been reached for the rolling period: stay at 100% probability of winning, for example, the next person to play will win.

Once a win has been noted by the gaming module, the gaming module may send the tracking and fulfillment information to the prize module.

There are several fields that will need to be setup per project or per program. Some of these may be hard-coded into the training system while other will be changeable by an administrator or other specified user. In one embodiment, historical data may not be recorded in case fields are changed after the gaming module is launched. In an other embodiment, historical data may be tracked including information as to who and when each field was last changed/saved and display this information next to each field in an administration page. As mentioned previously, front-end related fields may have multi-lingual capabilities.

In some gaming applications within the gaming module bonus points and penalty points may be used to increase or decrease the credits available to an associate or store or other entity level.

Through the prize module, prizes may be grouped and a group may be assigned to a specific post-quiz, specific program, or specific competition. Prize management may be independent from post-quiz and gaming module logic presented above. Each post-quiz may have its own groups of prizes and each prize group might be simultaneously used by multiple post-quizzes. Prizes may be in multiple groups or groups may be pooled to create further groups of prizes.

The prize module is intended to manage the pool of prizes: what items there are, how many, tracking of how many were won, etc. Each group of prizes once created may be updated, for example, through a script that runs at a predetermined interval, for example nightly, or in real-time.

Once a win has occurred, the store manager may be notified by email or through an online message. The prize module will interact with the gaming module to provide the details of the win in the message. The prize module will also include a prize group list, which may list the post-quiz(zes) and programs-competitions that each prize group or product is associated with.

As noted above, the training system may include bonus points or penalty points that can be applied in various situations. The bonus point module may only add exceptional bonus points and may be accessible and administrated by an admin user. These points may reward users, or entities for meeting a profitability target or certification level or other commendable event.

Since bonuses and penalties may almost mirror the winning points rules of the program templates, the bonuses and penalties could be part of the template configuration. However, since bonuses and penalties may be somewhat standard across several programs, it may be better to have a module to manage them independently. Penalty points may be based on events such as receiving a safety claim or having property damage over a certain value.

Both penalty ID and title may be included in the “error page” that may be displayed when an associate logs in or tries to access the program. The program may be paused. Similarly, managers who would see the penalties listed in the store report and would want to understand where the negative points came from could see the title and the description of the penalty.

The ability to say if a specific penalty affects all programs, or only (a) certain program(s) is also contemplated. This could be done by displaying the list of all running programs on the user interface. Optionally, an admin user may filter the list to apply to a more detailed level.

In a specific example, a store is undergoing three programs: 1) a Safety program, 2) a Loss Prevention program, 3) a survey. In the configuration, these programs were set to respond differently to penalties: when a penalty is entered, the Safety program is halted and there are penalty points that are applied; the Loss Prevention program would apply penalty points: whereas the survey does not get affected by penalty points at all. A (one) claim is entered for this store, which corresponds to a halt of 7 days and 10 penalty points. As a result, when associates log in next, they cannot access the Safety program for the next 7 days, but can access both the Loss Prevention and the survey. They have −10 points on the Safety program and −10 points on the Loss Prevention program.

It may happen that penalties are contested and that the program managers agree that a penalty was wrongly entered or abusive. In this case, penalties can be reverted.

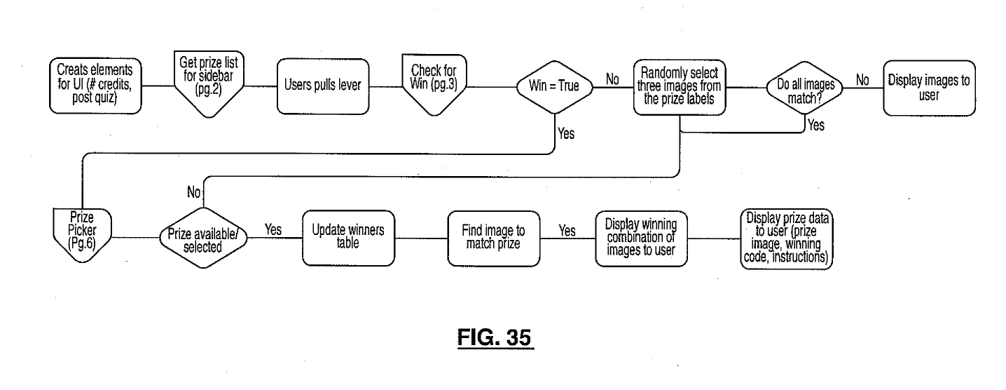

FIGS. 35 to 40 illustrate in flow chart form the flow of the prize module. The prize module handles prizes such as cash or points that are awarded when an associate, store or the like wins.

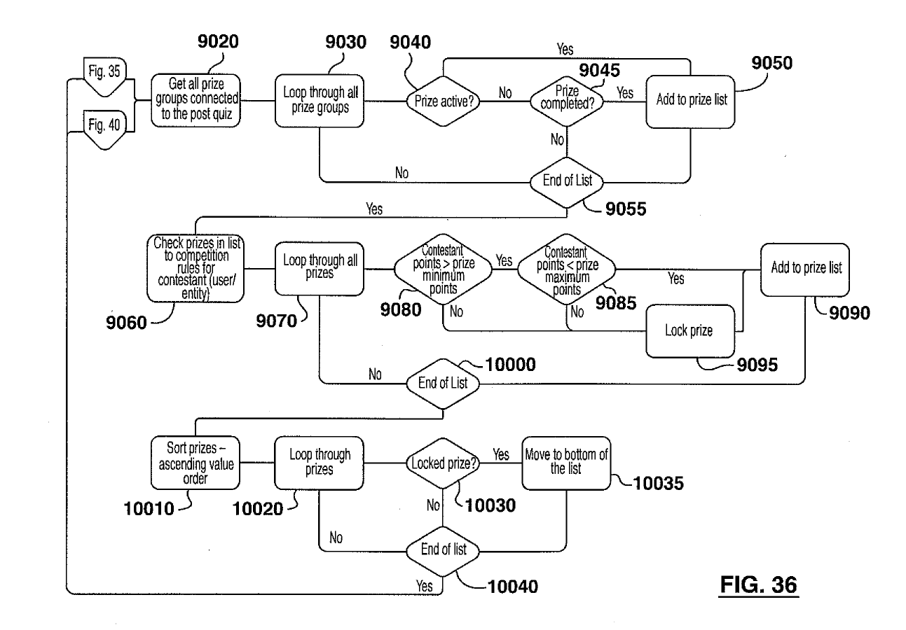

Referring to FIG. 35, first the elements for the user interface must be created 9000. For example, the prize module must determine the number of credits that user has and which post-quiz module the user is engaged in. The prize module then determines the prize list to be shown on the sidebar 9010 using the process shown in FIG. 36.

The prize module first collects all the prize groups currently connected to the specific post-quiz 9020. Looping though the prize groups 9030, it will determine if the prize is still an active prize 9040 and if so, the prize will be added to the prize list 9050, otherwise if the prize is completed 9045 or all the active prizes have been added to the prize list 9055, the prize module will then check the prizes within the list and compare them 9060 to the competition rules based on the user and entity engaging the prize module. The prize module will loop through 9070 the prizes and compare the contestant's or user's points with the prize's minimum 9080 and maximum point 9085 requirements. If the prize falls within this range it will be showcased as an unlocked 9090 prize, otherwise it will be shown as a locked prize 9095. The process will continue until the prize list is complete 10000.

The prize module then sorts the prizes 10010 by ascending value. Finally it will loop through 10020 the prizes and move the locked prizes 10030 to the bottom of the list 10035. The resulting prize list is returned 10040 may be displayed to the user of the post-quiz module.

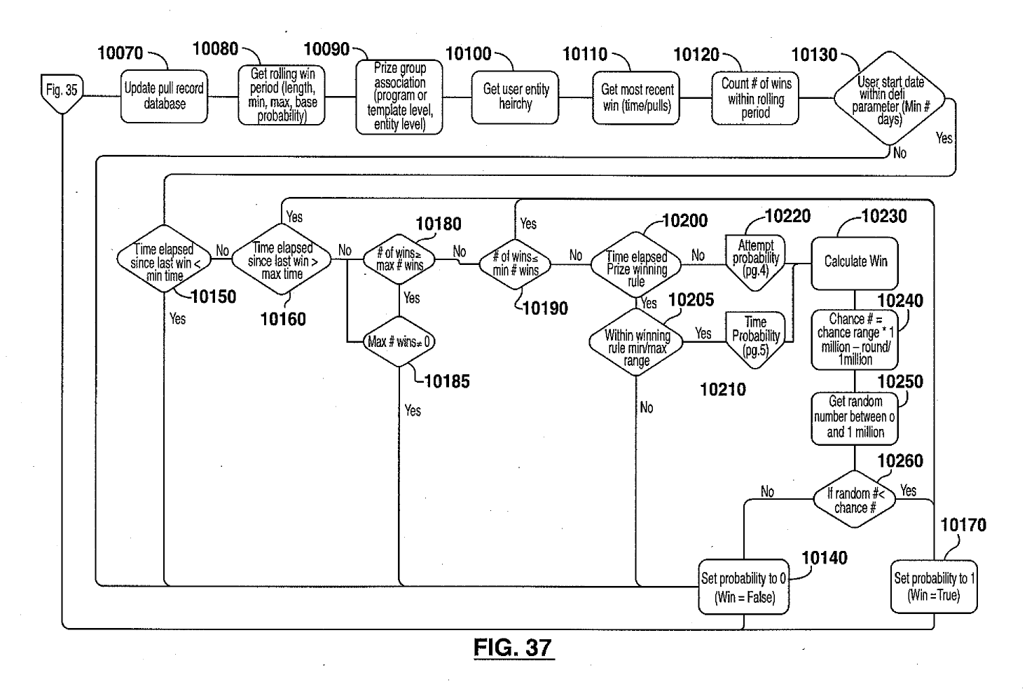

Returning to FIG. 35, the user then pulls the lever 10050, if the game is the one-arm bandit, or otherwise initiates the game if another game is selected. After the game is initiated, the prize module determines whether or not there is a win 10060 as shown in FIG. 37. First the prize module may update the number of tries 10070 (or pulls for the one-arm bandit) in the record base, then determine the rolling win period 10080 based on the parameters within the post-quiz module or the training system, for example the length of time since last win, maximum and minimum numbers of wins etc. The prize module also determines the prize group association 10090 and gets the user entity hierarchy 10100.

The prize module then retrieves the most recent win 10110 and also counts the number of wins 10120 within the current rolling period and determines the user's start date 10130 to see if the user is eligible for a win. The post-quiz module of the training system may require a user to be actively participating for a threshold number of days prior to allowing the user to win. If this threshold is not met the chance of winning may be set to 0 and the user will not win 10140. Otherwise the prizes module reviews the parameters in the rolling period to determine if these are met to see if a win is possible.

The various parameters may be set by an admin or super user to not only ensure that at least a certain number of prizes will be distributed but also that the distribution is spread out through various time intervals and geographies. The prize module will check that the time from the last win is greater than a minimum threshold 10150, and if not the user will not win 10140. If the time since the last win is greater than a maximum threshold 10160 the user may automatically win 10170 as the system has not allowed a random win in the defined period. If the time is between the last win and the time of the game initiation is between the range the prize module will then determine the number of wins that have accrued within the current post-quiz instantiation 10180. If this number is above the maximum allowed wins 10185, the user will not win 10140 otherwise the prize module will compare the current number of wins with a minimum number of wins 10190. If the current win number is smaller than the minimum number of wins, the user will be automatically win 10170 to increase the number to be within the desired threshold.

If the current win number is within the desired range the prize module will then review whether time elapsed rules apply 10200. If time elapsed prize winning rules apply the prize module will determine whether the user is currently within the winning rule minimum and maximum range 10205. If not the user will not win 10140, if so time based probability of the win will apply 10210. Otherwise attempt based probability will apply 10220. Once these probabilities are calculated 10230, as further detailed below, the chance of the win is calculated. First the chance number is calculated by manipulating the chance range 10240 which may include rounding the number to ensure there are no decimal places and then ensuring it is within an acceptable range.

The prize number that determines a random number between 0 and, in this example, 1 million 10250. If the random number is less than the chance number 10260 the user will win 10170 otherwise the user will lose 10180. The chance and random numbers may be calculated on a larger or smaller basis than 1 million, as shown in FIG. 37, or through other known probability schemes.

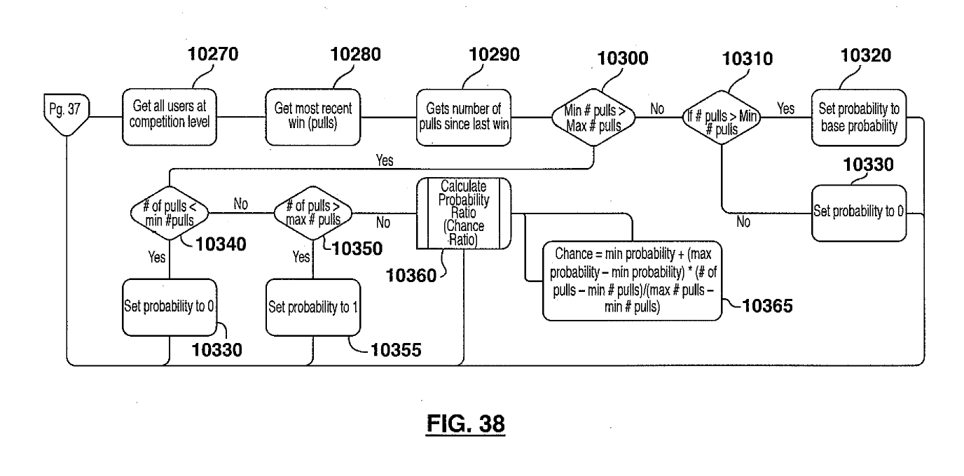

If attempt based probability is used at 10220 of FIG. 37, the prize module will follow the flow shown in FIG. 38. First number of users at the competition level is determined 10270, and then the most recent win 10280 and the number of gaming attempts since last win is determined 10290. The prize module will then determine whether there has been a range, with respect to the number of games played, previously inputted into the system 10300. If there is no range the prize module will check to see if a minimum number of attempts has been set. If the number of pulls is greater than the minimum number of attempts required to win 10310 the probability will be set to the base probability 10320. If there have been less attempts or pulls than the minimum required for the next win, the probability will be set to zero 10330.

If there has been a range created, the prize module will first check that there has been a sufficient number of attempts to enable a win 10340. If insufficient attempts have passed the probability will the probability will be set to zero 10330. If there have been sufficient attempts the prize module will determine if the number of attempts has surpassed the maximum number of attempts 10350. If there have been more attempts than the predetermined maximum number of attempts the probability will be set to win to guarantee a win 10355. If the number of attempts is between the predetermined max and minimum number the prize module will calculate the probability ratio 10360. In one embodiment the ratio will be calculated as the minimum probability plus the difference between the maximum probability and the minimum probability multiplied by the ratio of number of pulls less the minimum number of pulls over the max number of pulls less the minimum number of pulls 10365. Other ways of calculating the probability are possible using other probability schemes and including reference to the minimum and maximum predetermined number of attempts between wins.

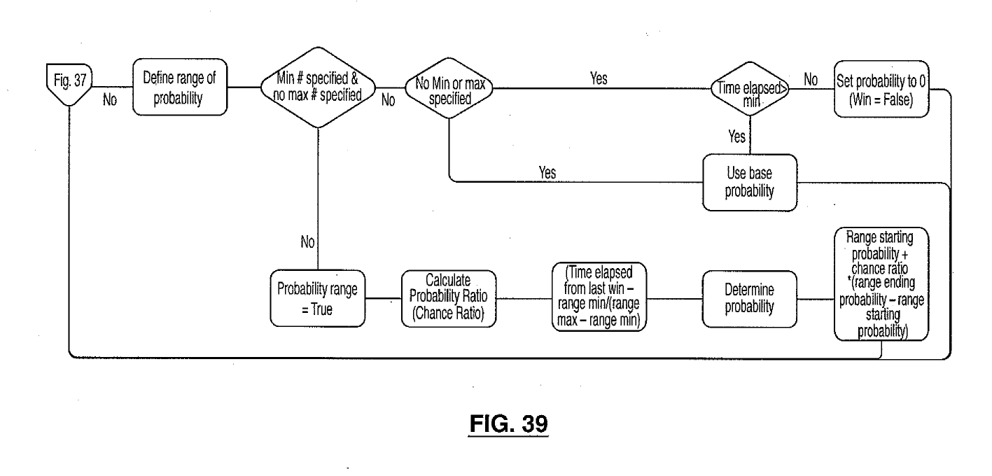

The flow of the time based probability (10210 in FIG. 37) is shown in FIG. 39. The prize module first defines the range of probability that has been previously set 10370. Then the prize module must retrieve a minimum and maximum time to win if these values have been set 10380. If no max or minimum time has been set 10390 the prize module will use the base probability to determine a win 10395. If a minimum time has been set the prize module will compare the time elapsed to the minimum time 10400. If sufficient time has passed the probability will be set to the base probability 10395, otherwise the probability will be set to zero 10405 to ensure the user does not win.

If the time of the attempts is within the probability range 10410 then the prize module can calculate the probability or chance ratio 10420. First the prize module may subtract from the time elapsed from the last win the range of time specified as the minimum over the difference of the maximum time less the minimum time 10430. After the range is determined the probability will be determined 10440. In one embodiment the probability may be the sum of the range starting probability and the chance ratio multiplied by the difference of the range ending probability from the range starting probability 10445.

Returning to the flow of the prize module in FIG. 35, if the win does not equal true 10450 the user does not win, non matching images will be selected 10460, and if the images do match 10470 the prize module will change the selection so that mismatching images are displayed to the user 10480.

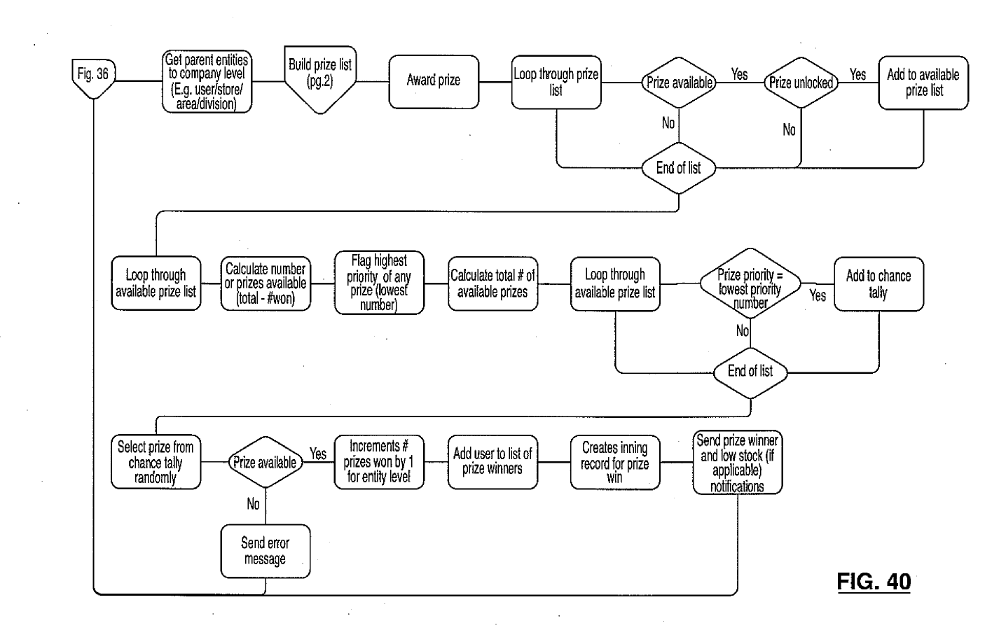

If the user does win 10450, the prize module will begin the flow for prize picking 10490 as illustrated in FIG. 40. First the parent entities of the user are determined 10500, and then the prize list is built in the same manner as when being built for the user interface 10505. The prize module awards a prize 10510. First it will loop through the prize list 10520 and filter the prizes on what is available 10530 and what is unlocked 10540 and add these prizes to the prize list 10545. Once this filtered list is created 10550 the prize module will calculate the total number of prizes that remain 10560 to be won, and then flag the highest priority of any prize 10565. The prize module will then calculate the total number of available prizes 10570 and loop through this list 10580 to add all prize priorities with the lowest priority 10590 to the prize chance tally list 10595. The prize module will then randomly select a prize 10600. If it turns out that this prize is not available 10610 an error message 10615 will be displayed, otherwise the information associated with the prize won will be updated 10620, the user will be listed as a prize winner 10630 and winning information will be determined for the prize win 10640. The prize module will also send prize notifications and low stock notification if any are required 10650.

Returning to FIG. 35, once the prize has been selected the prize module will check to ensure that the prizes are still available to win 10660 and that not all the prizes have been granted or the time on the gaming module has expired. If there are further issues the prize module will display three random and mismatched images 10460 and the user will not be a winner. Otherwise the prize module will update the winner's information 10670, selects the images that correspond to this prize 10680 and display these images to user 10690 as well as the prize data 10695.

### Reporting Module

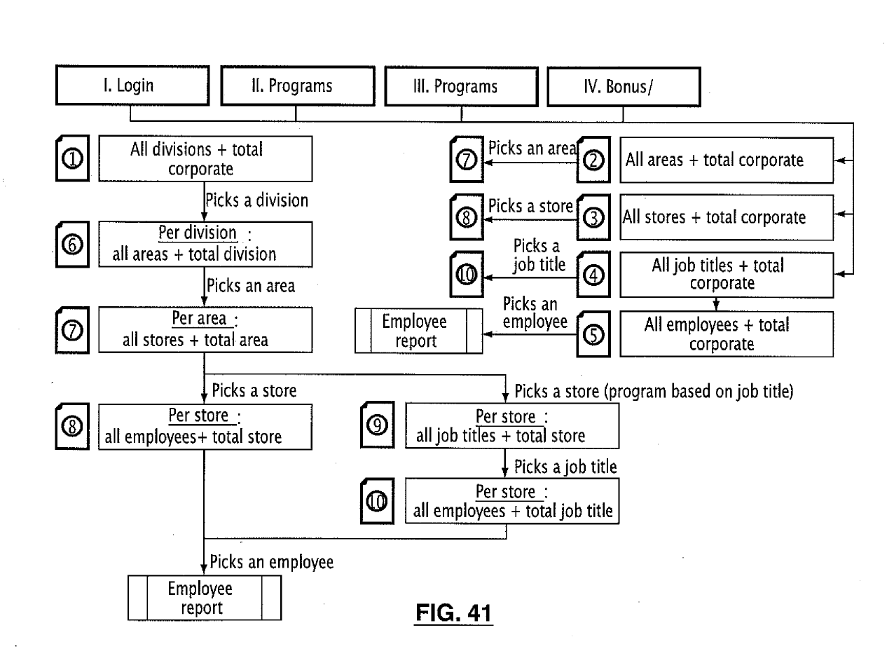

The training system further includes a reporting module that interacts with the other modules and may produce a variety of reports. An example work flow is illustrated in FIG. 41. This work flow illustrates the ability to drill down to various levels of data. Some examples of reports that are contemplated include:

Admin reports;

File upload report;

File upload exceptions report;

Program-template reports;

Questions reports;

Managers' reports:

Corporate reports;

Program reports;

Bonus/penalty reports; and

Associate reports.

Reporting may include aspects that allow the reports to be arranged based on user preference and displayed based on information that is more relevant to the specific user. Reports may be generated in various areas as the report module may interact and link the various modules described above.

The reporting module provides a feedback loop to managers and the corporation regarding the effectiveness of the programs and specific training modules. As the training system is adaptable to a user's knowledge and participation level, the reporting module allows management to review these statistics and the strengths and weakness currently contained within the workforce. The training modules and program instantiations may then be amended accordingly. The training system with the reporting module is intended to improve the directed nature of the trainings provided.

Email triggers may also be configured such that a report is emailed to certain users when it is created.

The reporting module is intended to interact with other modules, such as the quiz module, to create further reporting ability. For example, quiz module-specific reporting may include information on specific questions, for example, how often the question has been answered correctly, how often the question has been asked, the questions penetration rate (how many distinct users have answered the question).

Reporting of the distribution of how people answered the question and whether or not correct may also be available. An ability to drill down from company-wide to individual associates may be provided in this and in other reports produced by the reporting module.

Reports based on “Open-ended” questions such as survey questions, may include a list of associates (ID's) with answers they provided. This report may include the ability to filter or sort.

Reports may be configured to include or exclude data for predetermined employees (e.g. new or departing or other factors). Further tracking and amending the tracking parameters is also possible.

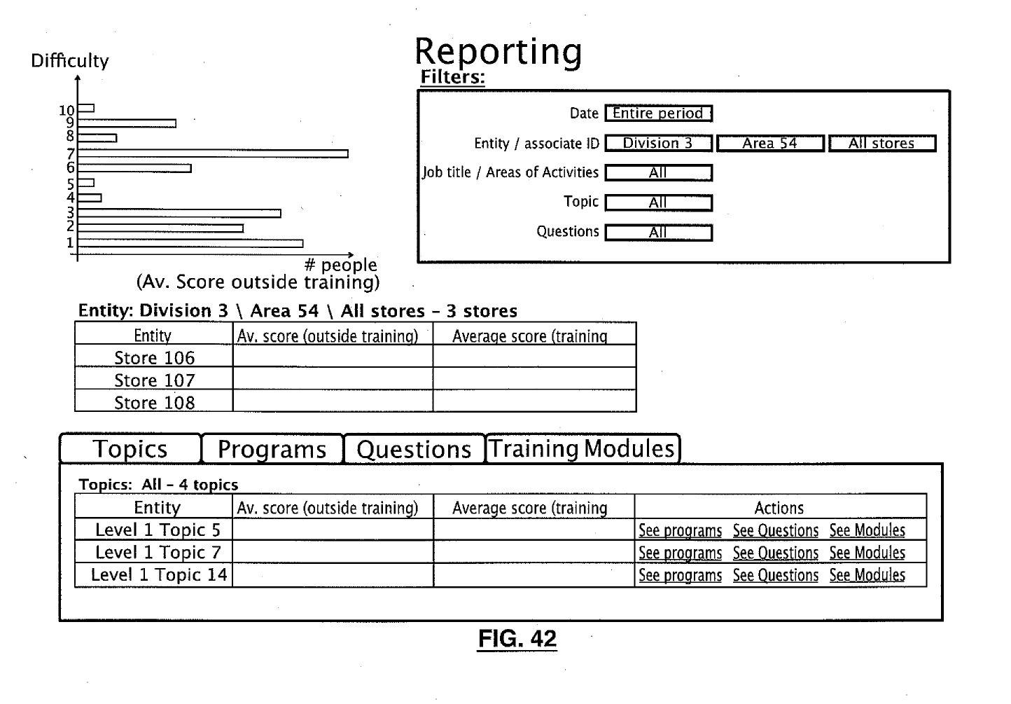

A report configuration page allows managers or other users to determine what default reports they would like to view on their home page. A example embodiment of a reports layout is shown in FIG. 42 and further discussed below.

A filter module may drill down step by step. The first drill down step may be to choose the type of report. Managers and admin users may have access to all or some specific reports and may drill up and down at will through the entire organization. The next step for drilling down may be to choose a program instantiation within a program template. Because of the program template and program instantiation structure, various instantiations within a template can have cumulated results. Conversely, statistics or information pertaining to different templates may be compared with one another.

The reports module may also include program-specific reporting, which may be different from operational reporting. It may specifically be related to reporting on templates and instantiations, such as:

Report of all templates with their status—display all “relevant fields” and allow to filter/sort on them;

Possibility to drill down to the instantiation level for each program;

Possibility to drill through and see per Lines of Business (LOB), divisions, areas, stores, job titles and even individual associates the list of program instantiations that they are currently undergoing; or

Possibility to see various stats per instantiations status per Lines of Business (LOB), divisions, areas, stores and job titles and further aspects.

Another type of report may be the programs and programs instantiations reports. The programs report may contain for example: % participation; % correct answers (or % success rate). In the programs report, these may be the aggregation of all programs instantiations that fall under the same program template, with the possibility to drill through to the program instantiation report, by choosing a single instantiation.

The elements of calculations may also be visible in the report or easily accessible, not just the percentages. For example, % participation=Number of questions answered/number of potential questions that could have been answered.

The reports might be narrowed down depending on click through options, for example, if a manager was looking at the statistics for all job titles within a store, and then click through to the next level, by clicking on one of the job titles, the manager could see statistics for associates in that position in that store.

A bonus/penalty report may contain the following elements: Sum of $ or points won/lost; Reason+other details for bonus/penalty; Rankings and Winners.

A historical comparison of a program, based on template, may also be included. A program winners' report, which might be quiz, pre-quiz or post-quiz based can also be provided.

Further elements may include a number of questions answered per associate per day or per session, a rolling 30-day average and rolling 60 days average, as well as min, and max values, aggregate per store, area, division and on company level and the ability to drill through (associate-level history).

Training-specific reports may be included in at least three types of reports derived from the training programs for example: reports on performance on the trainings and all related issues; reports based on log information; and individuals associate activity reports.

The training system may also provide the ability to switch views among the following, difficulty level, success rate, participation level, penetration level or log-type data such as time logged in and time between logins right from a report and have the same or similar layout with the data that was requested. The reports may also include the option to sort the report on the various fields.

Graphs may increase the readability of data. By providing illustrative feedback, users of the training system may easily gauge which areas are falling behind while which other areas are excelling. This feedback can be generated in real time and appropriate modification to the training programs instantiations and competition programs can be made quickly and efficiently to provide desired results. The graphs may be part of a report and displayed to the user via the user interface of the training system or the graphs and reports may be exported to another file format, for example a spreadsheet.

In one example, shown in FIG. 42, an example report layout may include 4 areas:

A main graph, in this case, displaying the count of associates per difficulty level attained;

A filter area which affects all other areas, which allows to filter on, for example,: Date, Entities (divisions, areas, etc.), Job Titles, Topic, Questions and Difficulty (range);

A first list which displays the detail for all entities selected; and

A second list which could include: Topics, Programs, Questions, Training Modules or Job Title (depending on tab that is selected). In some cases, the graph displayed may be updated based on the selection.

Prize reports may also be provided by the training system through the interaction between the prize module and the reporting module. A prize report may allow a user to select various filters similar to the filters for the program reports. The prize report may allow a user to see various prize statistics at any level of the organization and include information such as: what was won; when; by whom (any entity level); the overall quantity and value of the initial quantity of prizes; the overall quantity and value of what was won.

Other reports from the prize module may also be generated including reports referencing the overall prize budget, compared to the budget spent to date or the breakdown of the budget. In the prize module, other reports may be filtered similarly to the program report (since prizes are grouped per programs). Also provided in the reporting may be the ability to bring the report down to the individual associates and see when prizes were won.

Reports showing other prize details at various levels of the organization may also be generated as well as accounting information. The cost of the prizes can be reported to provide accurate costing information of the program and the prizes awarded.

### Other Functionality

Other back-end functionality may be included in the training system. For example, content management may include an ability to post pdf files which may be Newsletters and to list all past newsletters. A photo gallery may also be included that gives the user or client the ability to organize photos in categories and neatly displays them. Blog postings may be a further addition and a default blog module may be included as a component of the system.

Interactive feedback forms may give the ability for an associate to ask a question of management. In one embodiment, only the associate who sent the initial form would see the answer. In the alternative, all associates or associates in the same category may view the response.

### Use Cases

The following section provides various use cases that illustrate some of the work flow and functionality of the training systems and methods herein.

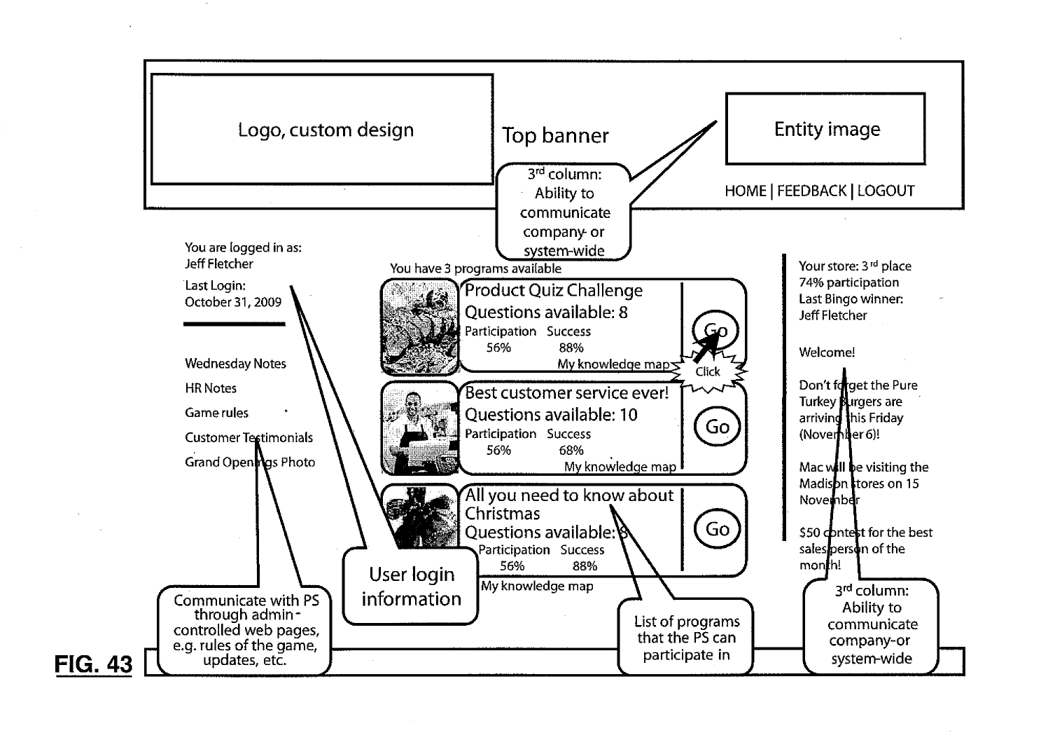

In one example, an associate use case is provided which entail a 2-3 minute training module based on adaptive profile. In this use case, the course will be assigned to the associate based on his actions and what is assumed to be his knowledge level by his responses to previous questions. A sample homepage for the user is seen in FIG. 43. The associate may choose to take the course after a few days, at which point the course may have become a mandatory pathway to the reward program, for example a Bingo game. The pathway may include:

1. Associate logs onto the system;

2. Sees Bingo game;

3. Answers a few questions; and

4. The system administrator may decide to run the script that may assign trainings to those who need them and may be done on a set periodicity: bi-weekly, weekly, every fortnight, etc.

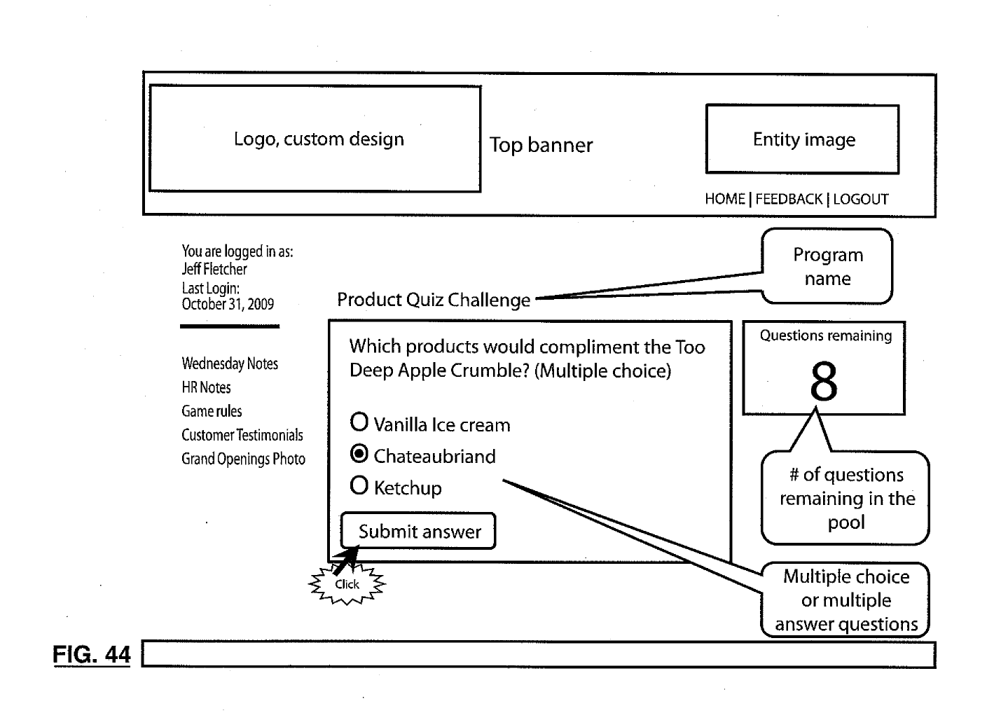

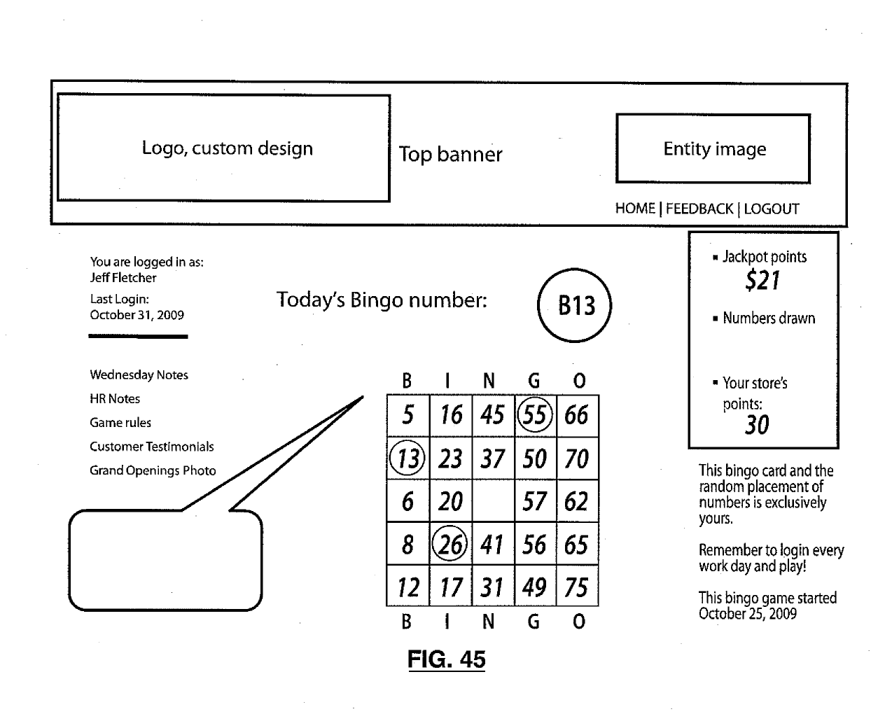

The system may identify that after specific random questions about fire safety that were asked repeatedly, this associate has only hit a 62% correct answer rate, for example an example of the question page in the quiz the associate may see is shown in FIG. 44. The associate may then be directed to a post-quiz engagement part of the training system, like the bingo game shown in FIG. 45.

The number of questions asked and the resulting score may be identified as a “trigger” for the training system to take action. The next time the associate logs in, he sees that a new program has been added to his list in the home page view. For example, it is the training module for fire safety. The training program may have a different logo than other programs, but otherwise the look of the dashboard and further pages may be consistent with the rest of the application.

The new program, in its overview, may indicate the traditional data that regular programs show; for example, questions available, participation, success rate, as well as remaining days that the associate has to take this training. In this case shown, the day remaining shows 3 days.

A customer may walk in and interrupts the associate. The associate may leave the system intending to get back to it before the end of his shift. But the day is busy, and he does not have time to get back to the system. His next opportunity to get to the system may be 4 days later. The associate logs in again. This time, the dashboard displays only one “clickable” program which is the fire safety course, the other programs may be grayed out. The number of remaining days may be set to 0.

The associate may decide to take the course and clicks on it. Three pages of information follow with text and may contain one image per page. The layout may change at each page and is intended to be friendly and lively. At the top of each page, the number of remaining “course” pages as well as the number of remaining questions may appear. Navigation buttons at the bottom of the page may provide the ability, for example, to go forward, backwards, back to beginning or directly to the end of the course.

After the course pages questions that may be randomly chosen by the system based on the categorization and the priority level out of a pool of the total questions. These questions may be asked as part of other programs as well as part of the course, except for those which may be specifically designated for the course. Note the multiple choice answers are also randomly ordered.

Once the course has been taken, a scorecard may be displayed and may show the number of correct and incorrect answers, for example.

The associate may be redirected back to the home page. The course may be displayed with 100% participation and the success rate. It may stay on the associate's dashboard for a predetermined period or may disappear immediately.

The associate may now be able to take all other programs, including the Bingo game, as seen in FIG. 45. In one case, he clicks on it, gets 4 questions, and one for each day that he has not logged in if the program is configured to offer one question per day. The associate may answer the questions all and finally reaches the Bingo card. In total, that day, the associate may have had to answer 8 questions: first on the specific topic of the course and 4 others, which may have been on the topic or on other topics.

In another specific associate use case scenario: an urgent and pervasive training may be pushed. If a training program is deemed absolutely and urgently necessary, whether it is across the entire company, for a specific job title or a specific store, it is always possible to configure a training program to be not only first priority, but also the only program that users can take before the users can proceed to the other programs available.

In one case, a fire starts in a store. Luckily no one is hurt and the material damage is limited. Nevertheless, the retailer is concerned and decides to provide, across the entire store, a specific training regarding fire safety to ensure that the very basic knowledge aspects of fire safety are covered.

A fire safety training program instantiation is created and applied to this store with a number of days before program becomes mandatory set to 0, meaning it needs to be taken immediately.

The very next minute, associates from the store login may see the fire safety program as the only program they are able to take. All other on-going programs may be grayed out.

The associates take the training and answer the questions and may subsequently, upon going to the home page, may be able to take other programs again, such as the Bingo game.

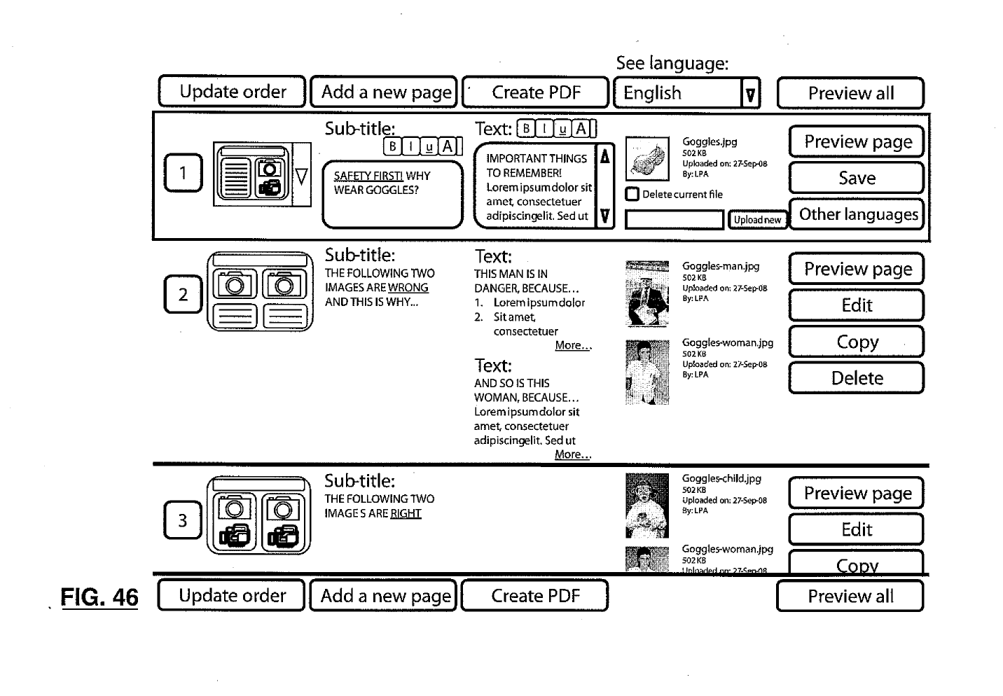

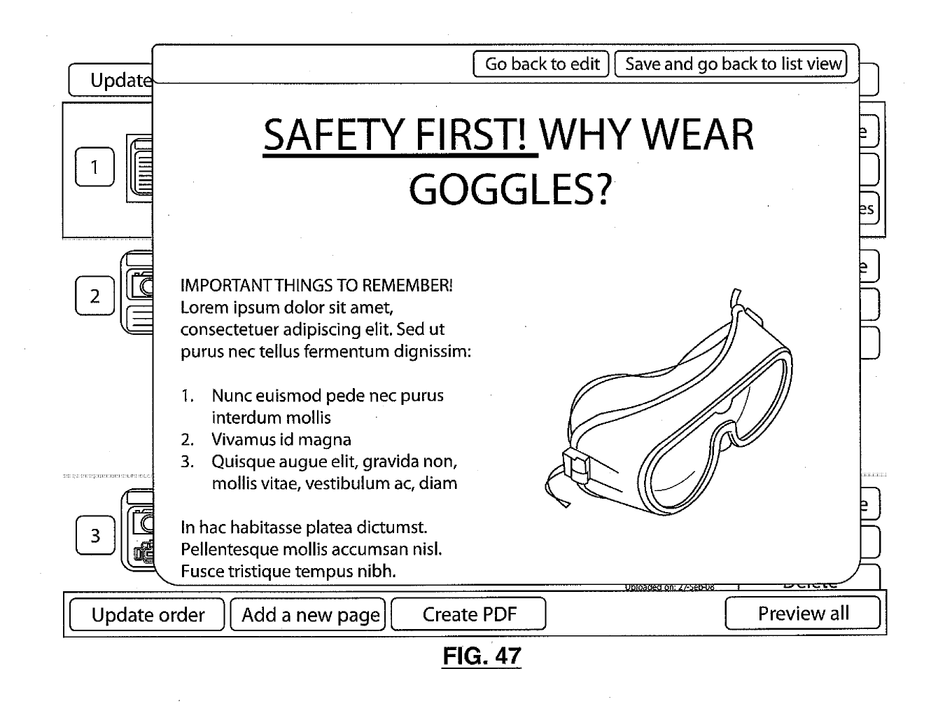

In one administrator use case scenario for creating a training instantiation of the process followed to create a new training is described as shown in FIGS. 46 and 47.

Upon digging through category aggregation statistics, per division, per area, per store, and per job title, the system administrator may notice that there seems to be a weakness in the more advanced questions regarding personal safety for cashiers. The administrator may check what the system currently holds in terms of personal safety trainings, and may realize that there are two trainings already available. Upon checking the reports about these trainings, she realizes that they have reached a certain level of saturation with cashiers but that nevertheless the results are indeed disappointing, for example, below 40% success. She reviews the training and realizes that the terms used may be too technical for the cashier population. She may decide to create a new training.

She may create a new training module on personal safety with a more simple approach: more pictures and less text. She then goes to the training program instantiations and selects the one pertaining to personal safety and may duplicate it. The administrator checks through the “training module picker utility” to ensure that her new module has indeed been properly associated. All of the other configuration items remain pertinent, so she does not touch them. She launches the new instantiation.

After a few weeks, she sees that the results on personal safety for cashiers seem to be greatly improving.

In another administrator use case scenario specifically about the training builder, an administrator may modify a training that is launched by, for example, retiring it and replacing it with a duplicate, and may add a new training page to the new training. The administrator may then ensure everywhere in the system, where the previous training was used, the new training will be picked.

In this case, an issue seems to have arisen on one of the trainings that is being given to associates. The image on one of the training pages seems to not correspond to the text that is displayed causing confusion on which may have decreased the performance of the training. The administrator wants to modify the training or, retire the training and create a duplicate with the proper image. Changing a component of the training that might impact the success rate of the training, for example, adding or editing text or an image for better comprehension, modifying the translation for a better one, even if the other versions remains the same, etc. are all actions that may prompt the administrator to create a new version of the training, instead of editing it.

She selects the training builder tool on the administration console. She then sees an overview of the trainings modules available in the application which may number in the hundreds or more. She may have the ability to search based on title, categories, status, date created, author, etc. and the ability to sort the results. She finally finds the specific training module that she wishes to edit. The administrator may then press a copy button and may be prompted by the system, for example: “would you like to simply create a new copy or also retire this current module once the new one will be active?”. The intent of this extra step offered by the system is to make it easier for administrators to update existing modules that do not collect the expected success rate in just one step instead of multiple steps. The administrator may then be taken into the training builder tool admin user interface. At this stage, she may not have to fill out the title, the description, the categories, etc. as they may be carried over from the previous training.

As this may be considered a new training, which has not yet been launched, she may modify each or all pages of the training.

For each page, the administrator can see the layout template of the page, the text, an overview of the picture if there is one, the name of the picture that was uploaded as well as, for example, three buttons on the right for each page: “preview”, “edit” and “delete”.

The administrator may click the edit button of the page she wishes to modify. In this case, the layout template becomes a drop-down box where more layout templates can be selected, text becomes a text editor, a file upload tool may appear near the name of the image, and a “save” button may appear above the other three. The administrator may select the proper image, and click on the “upload” button. The system then may upload the image and may check that its definition is appropriate. The system may resize the image so that it can fit within the layout template that has been selected. The administrator then saves the page, which takes her back to the overview of the various pages. The administrator may decide to add an additional page at the beginning of the training to make the sure that the premise for taking the training is understood by all associates. She clicks on the new button in this example. This adds a page at the bottom of the list with all fields active. She may pick a template, which is text only, enters the text, formats it and then presses the preview button. Other templates with other combinations of text or images may be selected. Happy with the result, she clicks on save and goes back to the overview page.

The administrator may drag the page to the top of the list. She clicks on the preview all button to see what the entire training looks like from the associate's perspective. Satisfied, she clicks on the provided button at the bottom of her screen that saves the training. The system prompts her: “would you like to launch this training module now?” She clicks on “yes”. The system displays the message “please wait until we update the system. This might take a few minutes”, after which she is taken back to the list view.

The action of saving the module updates the training module picker utility, which allows the administrator to see, in the module view, which active programs will be able to use this new module. This utility may allow her to check that the categorization of the module was done appropriately.

### Sophie and Fire Safety

1. Sophie, an associate, answers a series of 20 random questions that are asked through two of the competition programs that are currently offered in her store. All of them are at a level of difficulty 3.

2. That night the custom-script is not run by the system, as it is configured to run only once per week, on Sunday at 5 am

3. Sophie continues to answer questions. She knows that she has been doing relatively poorly every time questions about customer service and fire safety came up—these are definite knowledge gaps that she is aware of and that the system is starting to pick up

4. On Sunday at 5 am, the custom-script is run by the system (associates are not aware of this—this is an underground process)

5. The system identifies the two areas of weakness Sophie is subject to. Fire Safety has a higher priority than Customer Service. Since the system has been configured to offer only one training at a time (but up to two trainings per month), the system will offer the Fire Safety training first to Sophie. This specific training has a “days to complete” of 0, i.e. it takes precedence over all other programs right away.

6. On Monday morning, Sophie logs in and sees that she cannot access her regular competition games: she first has to take the Fire Safety training. She reads the 5 slides and answers the 5 questions. She gets 4 out of the 5 questions right—as indicated on the scorecard the follows the questions. This is not enough to consider to have passed this training which requires a 100% score. However, she has two more tries before the system will take action.

7. After three failed trainings, the system sends an email to the recipients listed for this program—this however does not affect the way questions or training programs are assigned to associates. The system, simultaneously, tunes the question picker to start asking level 1 and 2 questions to Sophie about Fire Safety (this lower level of difficulty is configured, in the custom script, as the next program if one consistently fails the Fire Safety training level 3).

8. Sophie nails all the Fire Safety questions level 1 and 2 that she gets as part of all the other questions that the system submits to her in the competition programs. The system therefore does not offer her the Fire Safety training level 2, it goes back to asking her level 3 Fire Safety questions.

In another specific case, Eric is shown where the system does not have a “next” program).

1. An associate, Eric, was previously a Fire Fighter which, due to an injury, could no longer pursue this career and decided to work instead as Fire Safety floor specialist. As every other associate in the store, Eric has to answer questions every day. He of course knows all the answers to Fire Safety questions.

2. As with Sophie, the system starts asking difficulty level 3 questions. After the custom script is run, the system sees that Eric has a 100% success rate at this level of difficulty. The script tells the question picker to bypass the Fire Safety training corresponding to this level of difficulty and, as a next step, to proceed with asking Fire Safety questions but at a higher difficulty level.

3. As Eric passes each stage of the fire Safety audit programs (questions only), there comes a point where there are no “next” step: Eric has completed the entire latter for that branch. After a number of iterations at the top level, the system will stop assigning this topic (program?) to Eric to leave room for other questions to be asked.

Another Use-Case scenario illustrates Patrick where the system does not have a “previous” program.

1. An associate, Patrick, is a student who works at A large retailer to buy a really cool stereo system. Nevertheless, he is not at all interested in cars and is quite disengaged from his work. The system identifies early that the Fire Safety difficulty level 3 questions are way beyond what Patrick has retained of his introduction course.

2. As for Sophie, an email is sent to the administrator while the system reduces the difficulty of the question to levels 1-2. There too, Patrick underperforms despite multiple trainings and a new email is sent to the administrator whom is currently trying to extinguish other fires and forgets to address Patrick's case.

3. The system now has no “previous” program to go to, as it has reached the lowest level of the hierarchy described in the custom script. It will continue asking level 1-2 questions and submitting associate to training until the loop is interrupted, either by an external HR intervention—based on admin email that was sent, or until associate finally learns something and passes the training level and goes to the next level.

### Case Studies

Subsequent to the filing of the related provisional application, Case studies have been performed to determine the training, retention and reinforcement results from a specific embodiment of the training system.

One case study concentrated on reducing health and safety workers' compensation losses and costs. The case study involved a retail and service company with about 17,000 employees across the United States. A strategy was determined using the system and methods described above. The system for training provided training and questions to employees based on their job function specific to areas of injury in three high loss Health & Safety categories: Slips & Falls, Strains & Sprains and Cuts & Lacerations. Through the iterative process that is inherent in the system for training, the employees gained a greater knowledge of safe working procedures in these specific high loss categories.

When the results were tabulated, all three of these High Loss Categories reported a dramatic improvement in knowledge among the employee base, which lead to a corresponding reduction in Workers' Compensation losses. The improved performance is believed to have resulted in approximately $6,000,000 savings in Workers' Compensation payments during an 18 month period.

In a second case study, training and questions were targeted at increasing knowledge and action on a tip line related to loss prevention. The same company as above wished to improve the quality and quantity of calls to the loss prevention tip line, an anonymous telephone line for reporting unethical employee behaviour.

After the initial launch of the initiative, which was included announcements, posters and discussion about the new line, it was discovered that only 48% of employees had a basic understanding of the loss prevention tip lineand its function. The system for training was then populated with questions specific to the loss prevention tip line initiative and pulsed to employees over a 30 day period. After the 5th iteration of loss prevention tip line specific questions during the 30 day period, employee knowledge had improved from 48% to over 98%. This resulted in a 30% increase in call-ins on the loss prevention tip line as well as a demonstrated improvement in the quality of tips generated (i.e. the tips were more detailed, more directly reflective of what constituted unethical behaviour as defined by the loss prevention tip line initiative, and more likely to lead to recovery and apprehension.) These tips lead to the recovery of stolen merchandise and the apprehension of dishonest employees.

These case studies, as well as end user comments received, indicate the synergistic effect of combining short burst of questions to reinforce training with reward-based incentives to encourage retention of information.

It will be understood that the systems and methods herein may be embodied in software or hardware or some combination thereof. In the case that the systems or methods are embodied in software, it will be understood that the software may be provided as computer-readable instructions on a physical medium that, when executed by a computing device, will cause the computing device to execute the instructions to implement the system or method.

It should be understood that various modifications can be made to the exemplary embodiments described and illustrated herein, without departing from the general scope of the appended claims. In particular, it should be understood that while the embodiments have been described for training in a work environment, the embodiments may be generally applicable to education in general. In particular, some commentators have indicated that the millenial generation takes more readily to short bursts of learning of the type described herein.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

1. A method for training comprising:
providing training to a user;
testing the user on the training, wherein the testing is performed in short, frequent bursts and continues for a predetermined period of time; and
rewarding the user based on results related to the training or testing.

2. The method of claim 1 wherein the testing in short bursts comprises testing less than approximately ten minutes per test.

3. The method of claim 1 wherein the testing in frequent bursts comprises testing more than approximately once every week.

4. The method of claim 1 wherein the testing is adapted to the user based on historical performance to predict areas of required testing.

5. The method of claim 1 wherein the rewarding comprises providing the user with a chance to win a prize.

6. The method of claim 5 wherein the chance of winning a prize is adjusted based on user parameters, prize parameters and results related to the training or testing.

7. The method of claim 5 wherein the chance of winning a prize is based on a combination of user settings and random selection.

8. The method of claim 1 wherein the rewarding comprises providing a user with a prize based on user performance.

9. The method of claim 8 wherein the user performance includes bonuses and penalties related to user or group performance.

10. The method of claim 1 wherein the rewarding comprises providing a user or group of users a prize based on the group performance.

11. A system for training comprising:
a training module for providing training to a user;
a testing module for testing the user on the training, wherein the testing is performed in short, frequent bursts and continues for a predetermined period of time; and
a reward module for rewarding the user based on results related to the training or testing.

12. The system of claim 11 wherein the testing module is configured to perform testing in short bursts lasting less than approximately ten minutes per test.

13. The system of claim 11 wherein the testing module is configured to perform testing in frequent bursts of more than approximately once every week.

14. The system of claim 11 wherein the testing module is configured to adapt the testing to the user based on historical performance to predict areas of required testing.

15. The system of claim 11 wherein the reward module is configured to provide the user with a chance to win a prize.

16. The system of claim 15 wherein the reward module is configured to adjust the chance of winning a prize based on a combination of user settings and random selection.

17. The system of claim 16 wherein the user settings may include a probability of winning and the probability of winning may be adjusted based on user parameters, prize parameters, and results related to the training or the testing.

18. The system of claim 11 wherein the training module also provides the training in short, frequent bursts and includes a testing component.

19. The system of claim 11 wherein the training module also provides the training based on historical results to predict areas of required training.
